(19) United States
(12) Patent Application Publication
(10) Pub. No.: US 2006/0001597 A1
(43) Pub. Date: Jan. 5, 2006

(54) Image processing apparatus, systems and associated methods

(76) Inventor: Sokbom Han, Phoenix, AZ (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/881,732

(22) Filed: Jun. 30, 2004

(51) Int. Cl. G09G 3/00; G09G 1/08

(52) U.S. Cl. 345/32; 345/15

(57) ABSTRACT

An embodiment includes a method that includes substantially removing a Moiré pattern from an image based on a blending of at least two lowpass filter operations in an accelerator of a first image signal processor. The method further includes transmitting the image from the first image signal processor to a second image signal processor through a logical connection that includes a number of ports of a number of other different image signal processors. The method also includes adding high frequency data, which was removed during the removing of the Moiré pattern from the image, back to the image using components of the second image signal processor.

### TECHNICAL FIELD

The application relates generally to data processing, and, more particularly, to image processing in a programmable media processor.

### BACKGROUND

Scanned halftone images that are represented with dots of different colors on printed documents, such as newspapers, magazines and books may create an undesirable pattern called Moiré due to the halftone dots and different scan settings regarding dots per inch (DPI).

### BRIEF DESCRIPTION OF THE DRAWINGS

Embodiments of the invention may be best understood by referring to the following description and accompanying drawings that illustrate such embodiments. The numbering scheme for the Figures included herein is such that the leading number for a given reference number in a Figure is associated with the number of the Figure. For example, a system 100 can be located in FIG. 1. However, reference numbers are the same for those elements that are the same across different Figures. In the drawings:

FIG. 1 illustrates a simplified block diagram of a system for shared decoding and deinterlacing of compressed video, according to some embodiments of the invention.

FIG. 2 illustrates a more detailed block diagram of an image processor, according to some embodiments of the invention.

FIG. 3 illustrates a more detailed block diagram of an image signal processor, according to some embodiments of the invention.

FIGS. 4 and 5 illustrate more detailed block diagrams of one or more image signal processors for descreening an image, according to some embodiments of the invention.

FIG. 6 illustrates a port ring and associated ports of an image signal processor, according to some embodiments of the invention.

FIG. 7 illustrates a First In First Out (FIFO) memory within a transmitter or receiver port and associated interface signals for the memory, according to some embodiments of the invention.

FIG. 8 illustrates a more detailed block diagram of a receiver port along with associated interface signals, according to some embodiments of the invention.

FIGS. 9A-9G illustrate a more detailed block diagram of a receiver port communicating with different transmitter ports, according to some embodiments of the invention.

FIG. 10 illustrates a more detailed block diagram of a transmitter port along with associated interface signals, according to some embodiments of the invention.

FIGS. 11A-11E illustrate a more detailed block diagram of a transmitter port communicating with different receiver ports that use different interface signals, according to some embodiments of the invention.

FIG. 12 illustrates a number of different routes for a given logical connection from a source image signal processor to a destination image signal processor, according to some embodiments of the invention.

FIG. 13 illustrates a flow diagram for establishing and initializing of a logical connection within an image processor, according to an embodiment of the invention.

FIG. 14 illustrates a flow diagram for processing of data by an image processor, according to some embodiments of the invention.

FIGS. 15A-15B illustrate flow diagrams for communications among memories of different ports in an image processor, according to some embodiments of the invention.

FIG. 16 illustrates a flow diagram for descreening an image, according to some embodiments of the invention.

FIG. 17 illustrates a system for a multi-image processor-to-processor communication in a data-driven architecture, according to another embodiment of the invention.

### DETAILED DESCRIPTION

Methods, apparatus and systems for descreening an image to remove a Moiré pattern are described. In the following description, numerous specific details are set forth. However, it is understood that embodiments of the invention may be practiced without these specific details. In other instances, well-known circuits, structures and techniques have not been shown in detail in order not to obscure the understanding of this description.

### System Description

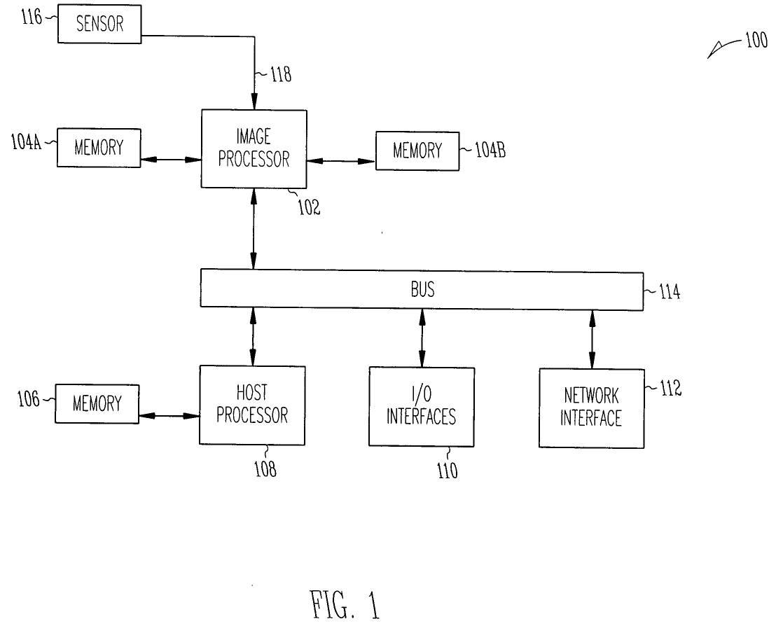

FIG. 1 illustrates a system for processor-to-processor communication in a data-driven architecture, according to some embodiments of the invention. FIG. 1 illustrates a system 100 that includes an image processor 102 that is coupled to receive an input data stream 118 from a sensor 116. While the sensor 116 may be of different types, in an embodiment, the sensor 116 is a Charge Coupled Device (CCD) sensor. In an embodiment, the sensor 116 is a Complementary Metal Oxide Semiconductor (CMOS) sensor. The sensor 116 scans and digitizes images, thereby producing the input data stream 118. For example, in an embodiment, the system 100 is embedded within a scanner that scans and processes images (such as documents, photos, etc.).

In an embodiment, the image processor 102 has an architecture that is data-driven, wherein the transmission and receipt of data across different elements within the image processor 102 drive the execution of the operations therein. In other words, a given operation within an element of the image processor 102 commences when the necessary data is available for execution.

The image processor 102 is coupled to memories 104A-104B. In an embodiment, the memories 104A-104B are different types of random access memory (RAM). For example, the memories 104A-104B are double data rate (DDR) Synchronous Dynamic RAM (SDRAM). As will be described in more detail below, elements within the image processor 102 store data related to image processing into the memories 104A-104B. To illustrate, a processor element within the image processor 102 may store results from a first image processing operation into one of the memories 104A-104B, which results are subsequently retrieved by a different processor element within the image processor 102 to perform a second image processing operation.

The image processor 102 is coupled to bus 114, which in an embodiment may be a Peripheral Component Interface (PCI) bus. The system 100 also includes a memory 106, a host processor 108, a number of input/output (I/O) interfaces 110 and a network interface 112. The host processor 108 is coupled to the memory 106. The memory 106 may be different types of RAM (e.g., Synchronous Dynamic RAM (SDRAM), DRAM, DDR-SDRAM, etc.), while in an embodiment, the host processor 108 may be different types of general-purpose processors. The I/O interface 110 provides an interface to I/O devices or peripheral components for the system 100. The I/O interface 110 may comprise any suitable interface controllers to provide for any suitable communication link to different components of the system 100. The I/O interface 110 for an embodiment provides suitable arbitration and buffering for one of a number of interfaces.

For an embodiment, the I/O interface 110 provides an interface to one or more suitable integrated drive electronics (IDE) drives, such as a hard disk drive (HDD) or compact disc read only memory (CD ROM) drive for example, to store data and/or instructions, for example, one or more suitable universal serial bus (USB) devices through one or more USB ports, an audio coder/decoder (codec), and a modem codec. The I/O interface 110 for an embodiment also provides an interface to a keyboard, a mouse, and one or more suitable devices, such as a printer for example, through one or more ports. The network interface 112 provides an interface to one or more remote devices over one of a number of communication networks (the Internet, an Intranet network, an Ethernet-based network, etc.).

The host processor 108, the I/O interfaces 110 and the network interface 112 are coupled together with the image processor 102 through the bus 114. As will be further described below, instructions executing within the host processor 108 configure the image processor 102 for different types of image processing. For example, the host processor 108 establishes a number of different logical connections among the different processor elements within the image processor 102. Further, the host processor 108 may download microcode to and check the status of the different components in the image processor 102 therein. To illustrate, a more detailed description of an embodiment of the image processor 102 will now be described.

### Image Processor

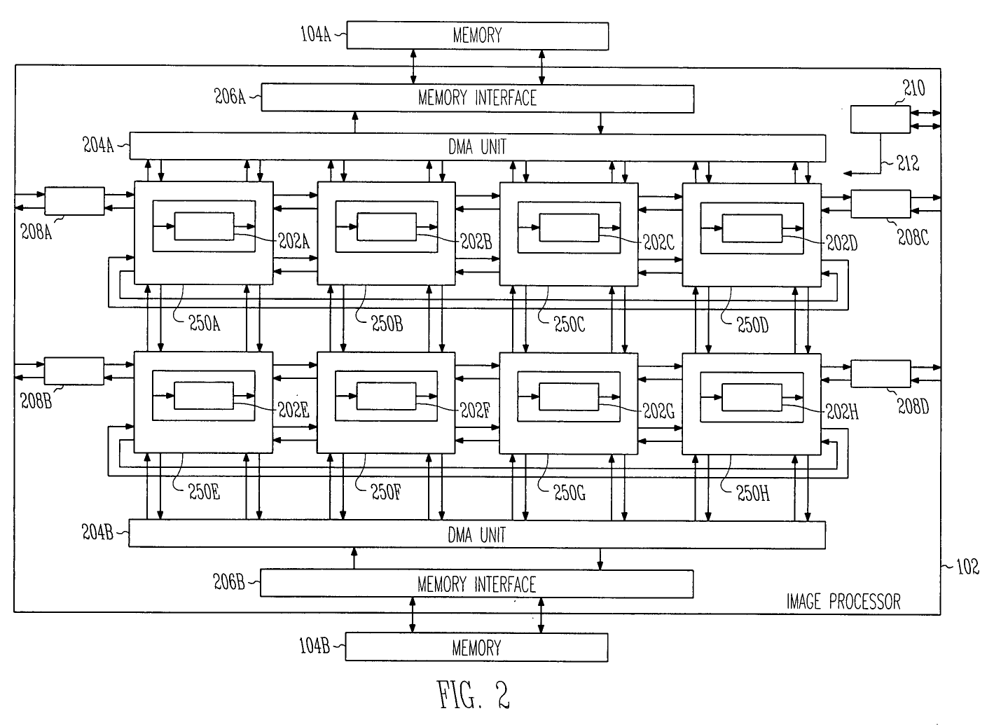

FIG. 2 illustrates a more detailed block diagram of an image processor, according to some embodiments of the invention. In particular, FIG. 2 illustrates a more detailed block diagram of the image processor 102, according to an embodiment of the invention. As shown, the image processor 102 includes image signal processors 202A-202H. The image signal processors 202A-202H include port rings 250A-250H, respectively. As further described below, the port rings 250A-250H include a number of ports through which the image signal processors 202A-202H transmit interface (control and data) signals. In an embodiment, a given port ring 250 includes eight I/O ports, wherein each such I/O port is a bi-directional connection such that data can be sent and received simultaneously through two separate unidirectional data buses. In other words, an I/O port includes a transmitter port and a receiver port.

The image processor 102 also includes a Direct Memory Access (DMA) unit 204A, a DMA unit 204B, a memory interface 206A and a memory interface 206B. Additionally, the image processor 102 includes an expansion interface 208A, an expansion interface 208B, an expansion interface 208C and an expansion interface 208D. The image processor 102 includes a bus/Joint Test Access Group (JTAG) interface 210. While FIG. 2 illustrates eight image signal processors 202, four expansion interfaces 208, two DMA units 204 and two memory interfaces 206, embodiments are not so limited, as a greater and/or a lesser number of such elements may be incorporated into embodiments of the image processor 102.

As shown, the interconnections among the image signal processors 202A-202H provide for a point-to-point nearest neighbor configuration, wherein a given image signal processor 202 is physically connected to four other elements (e.g., a different image signal processor 202, one of the expansion interfaces 208, one of the DMA units 204) within the image processor 102. In other words, a given image signal processor 204 is not physically connected to every other image signal processor 204 within the image processor 102. As further described below, data may be transmitted from a source image signal processor 202 to a destination image signal processor 202 through a series of intermediate image signal processors 202. In an embodiment, the transmission through the series of intermediate image signal processors 202 is such that the data is received on a receiver port of the intermediate image signal processor 202 and is outputted on a transmitter port of the intermediate image signal processor 202 through the port ring 250. Accordingly, no processor elements within the intermediate image signal processor 202 perform a process operation on the data as part of the transmission of the data from the source to the destination image signal processor 202.

Through the port ring 250A, the image signal processor 202A is coupled to the expansion interface 208A through one I/O port and is coupled to the port ring 250D of the image signal processor 202D through a different I/O port. Through the port ring 250A, the image signal processor 202A is coupled to the DMA unit 204A through two other different I/O ports. Through the port ring 250A, the image signal processor 202A is also coupled to the port ring 250B of the image signal processor 202B through two more different I/O ports. Further, through the port ring 250A, the image signal processor 202A is coupled to the port ring 250E of the image signal processor 202E through two other I/O ports.

Through the port ring 250B, the image signal processor 202B is coupled to the DMA unit 204A through two different I/O ports. Through the port ring 250B, the image signal processor 202B is also coupled to the port ring 250C of the image signal processor 202C through two other different I/O ports. Through the port ring 250B, the image signal processor 202B is coupled to the port ring 250F of the image signal processor 202F through two more different I/O ports.

Through the port ring 250C, the image signal processor 202C is coupled to the DMA unit 204A through two different I/O ports. Through the port ring 250C, the image signal processor 202C is also coupled to the port ring 250D of the image signal processor 202D through two other different I/O ports. Through the port ring 250C, the image signal processor 202C is coupled to the port ring 250G of the image signal processor 202G through two more different I/O ports.

Through the port ring 250D, the image signal processor 202D is coupled to the DMA unit 204A through two different I/O ports. Through the port ring 250D, the image signal processor 202D is also coupled to the expansion interface 208C through one I/O port and is coupled to the port ring 250A of the image signal processor 202A through a different I/O port. Through the port ring 250D, the image signal processor 202D is coupled to the port ring 250H of the image signal processor 202H through two more different I/O ports.

Through the port ring 250E, the image signal processor 202E is coupled to the expansion interface 208B through one I/O port and is coupled to the port ring 250H of the image signal processor 202H through a different I/O port. Through the port ring 250E, the image signal processor 202E is coupled to the DMA unit 204B through two other different I/O ports. Through the port ring 250E, the image signal processor 202E is also coupled to the port ring 250F of the image signal processor 202F through two more different I/O ports. Further, through the port ring 250E, the image signal processor 202E is coupled to the port ring 250A of the image signal processor 202A through two other I/O ports.

Through the port ring 250F, the image signal processor 202F is coupled to the DMA unit 204B through two different I/O ports. Through the port ring 250F, the image signal processor 202F is also coupled to the port ring 250G of the image signal processor 202G through two other different I/O ports. Through the port ring 250F, the image signal processor 202F is coupled to the port ring 250B of the image signal processor 202B through two more different I/O ports.

Through the port ring 250G, the image signal processor 202G is coupled to the DMA unit 204B through two different I/O ports. Through the port ring 250G, the image signal processor 202G is also coupled to the port ring 250H of the image signal processor 202H through two other different I/O ports. Through the port ring 250G, the image signal processor 202G is coupled to the port ring 250C of the image signal processor 202C through two more different I/O ports.

Through the port ring 250H, the image signal processor 202H is coupled to the DMA unit 204B through two different I/O ports. Through the port ring 250H, the image signal processor 202H is also coupled to the expansion interface 208D through one I/O port and is coupled to the port ring 250E of the image signal processor 202E through a different I/O port. Through the port ring 250H, the image signal processor 202H is coupled to the port ring 250D of the image signal processor 202D through two more different I/O ports.

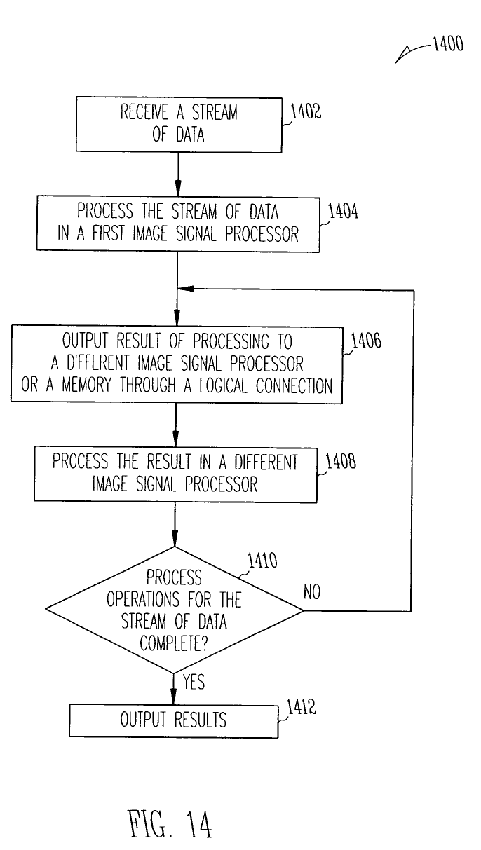

The expansion interfaces 208A-208D may also be externally coupled to different external devices. In an embodiment, the expansion interfaces 208A-208D may be externally coupled to other image processors 102, thereby allowing for the expansion of the number of image signal processors 202 that can communicate and process image data together. In an embodiment, a number of the image processors 102 may be daisy-chained together to allow for the processing of data across a number of different image processors 102. An exemplary embodiment is described in more detail below in conjunction with FIG. 14.

In an embodiment, the input data bus from the expansion interface 208A into the image signal processor 202A is 16 bits wide, while the associated output bus between the expansion interface 208A and the image signal processor 202A as well as the input/output data buses between the expansion interfaces 208B-208D and the image signal processors 202D, 202E and 202H, respectively, are eight bits wide. In such an embodiment, the expansion interface 208A can be used to receive data from the sensor 116 and to input such data into the image signal processor 202A using a comparatively larger width data bus. Also, as shown, the expansion interface 208D is coupled to the DMA unit 204B.

The DMA unit 204A is coupled to the memory interface 206A. The memory interface 206A is coupled to the memory 104A. The DMA unit 204B is coupled to the memory interface 206B. The memory interface 206B is coupled to the memory 104B. As will be described in more detail below, data (such as output from a result of an image process operation from one of the image signal processors 202) can be stored into and read from the memories 104A-104B through the DMA units 204A-204B and memory interface 206A-206B, respectively.

The bus/JTAG interface 210 may be externally coupled to the bus 114 to allow for communication/testing of the image processor 102. For example, the host processor 108 may configure the image processor 102 through the bus/JTAG interface 210. Moreover, the bus/JTAG interface 210 is coupled to an internal global bus 212. Although not shown in FIG. 2, the internal global bus 212 is coupled to the different elements within the image processor 102. Accordingly, external devices (e.g., the host processor 108) may directly communicate with/configure each of the different elements within the image processor 102.

### Image Signal Processor

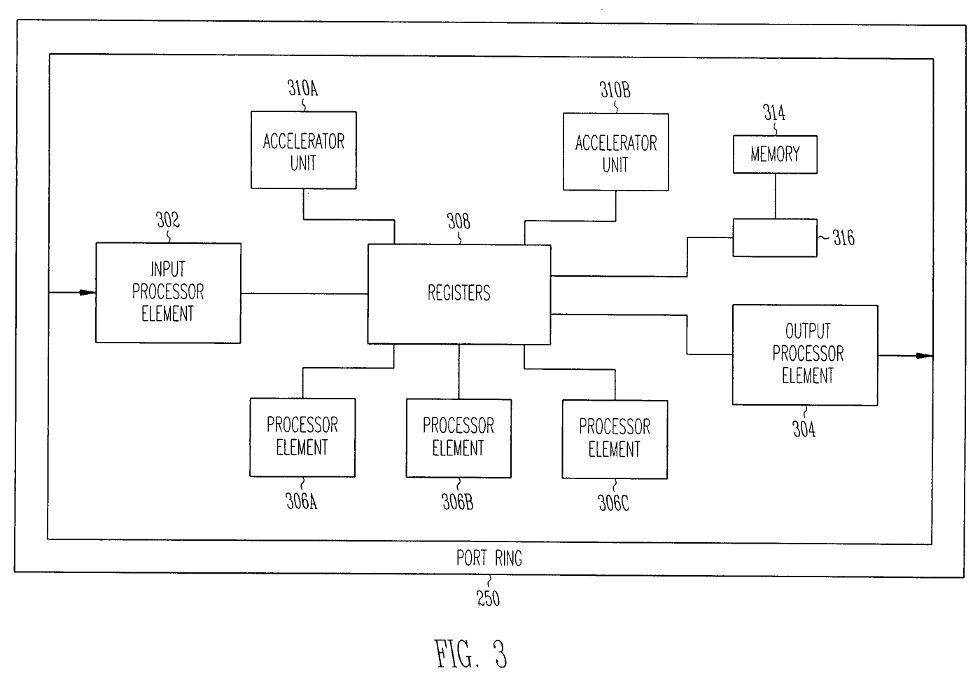

FIG. 3 illustrates a more detailed block diagram of an image signal processor, according to some embodiments of the invention. In particular, FIG. 3 illustrates a more detailed block diagram of one of the image signal processors 202, according to an embodiment of the invention.

The image signal processor 202 includes an input processor element 302, an output processor element 304, a number of processor elements 306A-306C, a number of registers 308, a number of accelerator units 310A-310B, a memory 314 and a memory controller 316. The input processor element 302, the output processor element 304, the processor elements 306A-306C, the accelerator units 310A-310B and the memory 314 (through the memory controller 316) are coupled to the registers 308. The registers 308 allow the processor elements 302, 304 and 306, the accelerator units 310A-310B and the memory 314 to exchange data and can be used as general-purpose registers for a given processor element 302, 304 and 306 and the accelerator units 310A-310B. Moreover, the processor elements 302, 304 and 306 and the accelerator units 310A-310B may include a number of local registers (not shown).

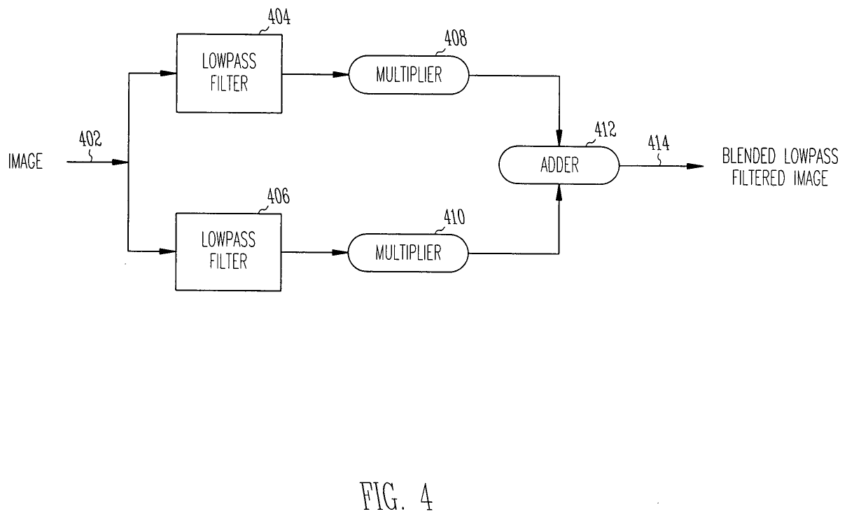

In an embodiment, the input processor element 302, the output processor element 304 and the processor elements 306A-306C include an instruction memory and an arithmetic-logic unit (ALU) for processing of the data. The input processor element 302 and the output processor element 304 are coupled to the ports of the image signal processor 202 through the port ring 250 to receive data being inputted into and to transmit data being outputted from, respectively, the image signal processor 202 (which is described in more detail below in conjunction with FIG. 4). In addition to inputting and outputting of data, the input processor element 302 and/or the output processor element 304 may process the data (similar to the processing provided by the processor elements 306A-306C). The different processor elements 306A-306C may be general-purpose processor elements or special-purpose processor elements.

For example, the processor elements 306A-306C may be Multiply-Accumulate (MAC) processor elements that include an instruction set for general-purpose processing as well as an instruction set for MAC functionality. The processor elements 306A-306C may be a combination of general-purpose processor elements and special-purpose processor elements. For example, the processor elements 306A and 306C may be MAC processor elements, while the processor element 306B may be a general-purpose processor element. While FIG. 3 illustrates five processor elements within the image signal processor 202, in other embodiments, a lesser or greater number of such processor elements may be incorporated into the image signal processor 202.

The input processor element 302 is a general-purpose processor element with a port interface as an input port. In an embodiment, the instructions within the input processor element 302 have the ports as additional input operands along with the registers 308 and the local registers within the input processor element 302. The output processor element 304 is a general-purpose processor element with a port interface as an output port. In an embodiment, the instructions within the output processor element 304 have the ports as additional output operands along with the registers 308 and the local registers within the output processor element 304.

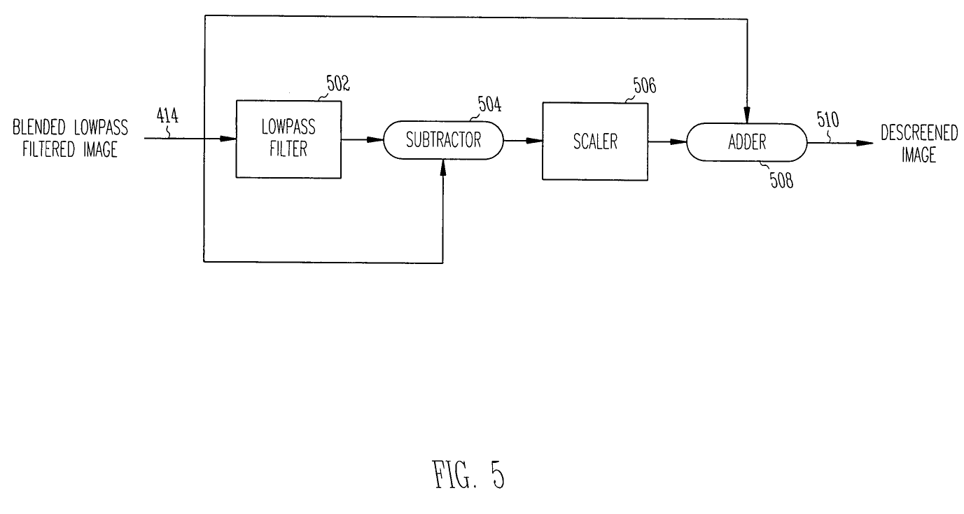

FIGS. 4 and 5 illustrate more detailed block diagrams of one or more image signal processors for descreening an image, according to some embodiments of the invention. In particular, FIGS. 4 and 5 illustrate more detailed block diagrams of the accelerator units 310 and the processor elements 306 within the image signal processors 202.

FIG. 4 includes a lowpass filter 404, a lowpass filter 406, a multiplier 408, a multiplier 410 and an adder 412. An input of the lowpass filter 404 and an input of the lowpass filter 406 are coupled to receive an image 402. The output of the lowpass filter 404 is coupled to the input of the multiplier 408. The output of the lowpass filter 406 is coupled to the input of the multiplier 410. The output of the multiplier 408 is coupled to a first input of the adder 412. The output of the multiplier 410 is coupled to a second input of the adder 412. The output of the adder 412 is a blended lowpass filtered image 414.

FIG. 5 includes a lowpass filter 502, a subtractor 504, a scaler 506 and an adder 508. The input of the lowpass filter 502, a first input of the adder 508 and a first input of the subtractor 504 are coupled to receive the blended lowpass filtered image 414. The output of the lowpass filter 502 is coupled to a second input of the subtractor 504. The output of the subtractor 504 is coupled to an input of the scaler 506. The output of the scaler 506 is coupled to a second input of the adder 508. An output of the adder 508 is the descreened image 510.

The different components shown in FIGS. 4 and 5 may be in different parts of one or more of the image signal processors 202. For example, the lowpass filter 404 may be in a first accelerator unit 310, and the lowpass filter 406 may be in a second accelerator unit 310. Additionally, the multiplier 408, the multiplier 410 and the adder 412 may be in one or more of the processor elements 302-306. In some embodiments, the lowpass filter 404 and the lowpass filter 406 that are in the accelerator units 310 may be in different image signal processors 202. In some embodiments, the lowpass filter 404 and the lowpass filter 406 in the accelerator units 310 are in a same image signal processor 202. The multiplier 408, the multiplier 410 and the adder 412 may be in the processor elements 302-306 that are in different or the same image signal processor 202 relative to each other and/or the lowpass filters 404-406. Similarly, the lowpass filter 502, the subtractor 504, the scaler 506 and the adder 508 may also be in a same or different image signal processor 202 relative to each other and/or the lowpass filters 404-406, the multiplier 408, the multiplier 410 and the adder 412. If the different components shown in FIGS. 4 and 5 are in different image signal processors 202, the data may be communicated among such components using suitable logical connections (as further described below).

In some embodiments, the lowpass filters 404, 406 and/or 502 may be variable triangular filters, single triangular filters, Gaussian filters, etc. The image signal processors 202 may be configured such that for a given image signal processor 202, one accelerator unit 310 includes a variable triangular filter, while a second accelerator unit 310 includes a single triangular filter. A variable triangular filter may generate multiple outputs based on different filter kernel sizes. Therefore, in some embodiments, the lowpass filter 404 and the lowpass filter 406 may be part of a same variable triangular filter in one accelerator unit 310.

As shown, FIG. 4 allows for a configurable blending of two different lowpass filter operations. In an exemplary embodiment, the lowpass filters 404-406 are variable triangular filters. In an alternative embodiment of FIG. 4, the configuration may only include a lowpass filter wherein the blending operation is not performed. In such an embodiment, FIG. 4 only includes one of the lowpass filters 404/406 (i.e., the multipliers 408-410 and the adder 412 are not needed).

The lowpass filters 404, 406 and/or 502 may have filter kernel sizes of 3×3, 5×5, 7×7, 9×9, 11×11, etc. In some embodiments, the lowpass filters 404, 406 and/or 502 may perform a source pass-through (no filtering). If the blending operation is performed, the outputs from the lowpass filters 404-406 may be blended in different percentages by the multipliers 408-410 and adder 412. For example, in some embodiments, the output from the lowpass filter 404 may be multiplied by 0.25, while the output from the lowpass filter 406 may be multiplied by 0.75. In a further example, the output from the lowpass filter 404 may be multiplied by 0.50, while the output from the lowpass filter 406 may be multiplied by 0.50.

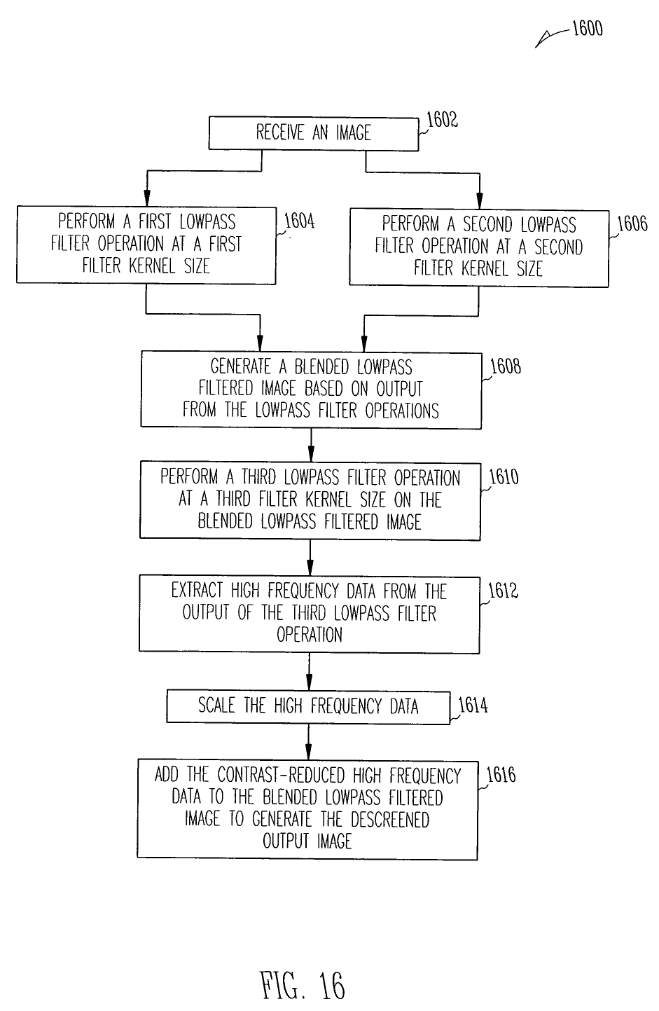

As further described below, the components of FIGS. 4 and 5 provide two different stages for descreening of an image. A first stage may include an initial lowpass filtering to remove a Moiré pattern from the image. A second stage may perform an unsharp masking to enhance edge information of the blurred image (generated by the first stage). Unsharp masking is a process that enhances the sharpness of an image using an operation that subtracts an unsharp (or smoothed) version of an image from an original image to extract high frequency information that gets added to the original image. The different filter kernel sizes and the blending percentages may depend on the level of Moiré noise in the original input image (which may be a function of scan resolution and scan material). Some embodiments of the operations of the components of FIGS. 4 and 5 are described in detail below in conjunction with FIG. 16.

### Port Ring and Ports of an Image Signal Processor

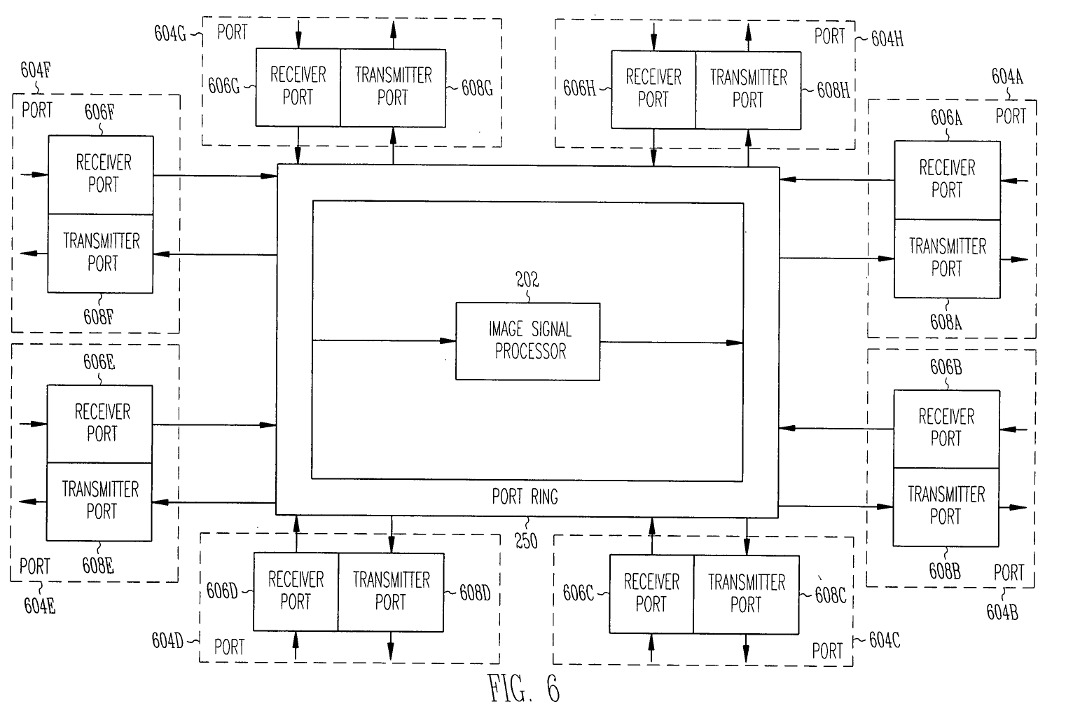

FIG. 6 illustrates a port ring and associated ports of an image signal processor, according to some embodiments of the invention. The image signal processor 202 is coupled to input and output data to and from ports 604A-604H through the port ring 250. As shown, in an embodiment, the ports 604A-604H are bi-directional data connections that allow for data to flow from one image signal processor 202 to a different unit (such as a different image signal processor 202, one of the DMA units 204, or one of the external interfaces 208).

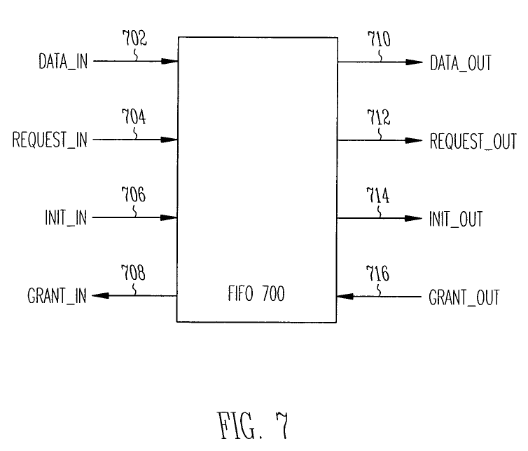

A given port 604A-604H comprises a receiver port and a transmitter port for receiving data into and transmitting data out from the port 604, respectively. In particular, the ports 604A-604H include receiver ports 606A-606H and transmitter ports 608A-608H, respectively. An embodiment of a receiver port and an embodiment of a transmitter port are described below in conjunction with FIG. 6 and FIG. 7, respectively. In an embodiment, an image signal processor 202 is connected to an adjacent (nearest neighbor) image signal processor 202 (as illustrated in FIG. 2) through the ports 604A-604H.

An embodiment of receiver and transmitter port (within one of the ports 604) which includes FIFO memories will now be described. FIG. 7 illustrates a FIFO memory within a transmitter or receiver port and associated interface signals for the memory, according to some embodiments of the invention.

As shown, a FIFO memory 700 receives an init_in signal 706 and transmits an init_out signal 714, which (as described in more detail below) are control signals for initialization and generation of a logical connection that is used to transmit data through the different image signal processors 202. The FIFO memory 700 receives a data_in signal 702 that inputs data into one of the entries of the FIFO memory 700.

The FIFO memory 700 also illustrates a number of grant/request signals. As is further described below, in an embodiment, the ports 604 use a handshake protocol for the transmission of data based on these grant/request signals. Accordingly, this grant/receive protocol allows for a data-driven architecture, wherein the image process operations are driven by the data on which such operations execute.

The FIFO memory 700 receives a request_in signal 704, which is a control signal from a FIFO memory in a different port that inputs data into an entry of the FIFO memory 700. The FIFO memory 700 transmits a grant_in signal 708 to the different FIFO memory, in response to the request_in signal 704, that indicates that the different FIFO memory may transmit data into the FIFO memory 700.

The FIFO memory 700 transmits a request_out signal 712 to a FIFO memory of a different port to request the transmission of data from the FIFO memory 700 to the different FIFO memory. The FIFO memory 700 receives a grant_out signal 716 from the different FIFO memory, in response to the request_out signal 712. This grant_out signal 716 signals to the FIFO memory 700 that the different FIFO memory will receive data from the FIFO memory 700. The FIFO memory 700 transmits a data_out signal 710 that transmits data to the different FIFO memory that granted transmission of the data (through grant_out signal 716) in response to the request_out signal 712.

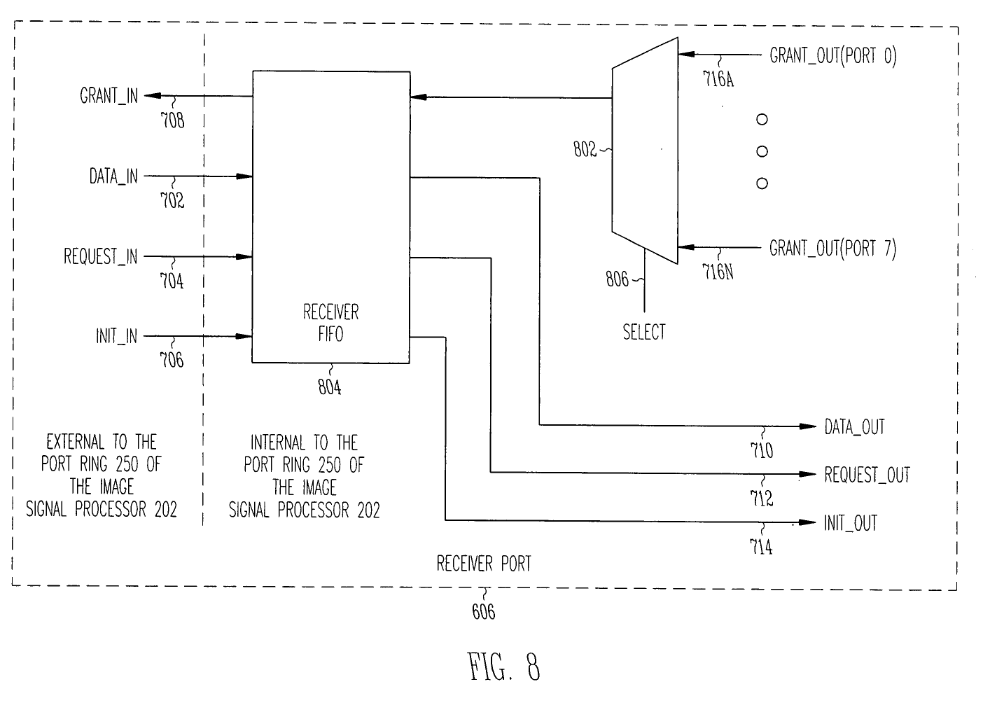

FIG. 8 illustrates a more detailed block diagram of a receiver port along with associated interface signals, according to some embodiments of the invention. In particular, FIG. 8 illustrates an embodiment of a receiver port 606 (that includes a receiver FIFO 804) and associated interface signals. The receiver port 606 is within one of the ports 604 (shown in FIG. 6) and receives data into the image signal processor 202.

The receiver FIFO 804 is coupled to receive and transmit interface signals (the grant_in signal 708, the data_in signal 702, the request_in signal 704 and the init_in signal 706) to and from a transmitter port 608 that is external to the port ring 250 of the image signal processor 202. The receiver FIFO 804 is also coupled to receive and transmit interface signals (a number of grant_out signals 716A-716N, the data_out signal 710, the request_out signal 712 and the init_out signal 714) from transmitter ports 608 that are internal to the port ring 250 of the image signal processor 202 or a processor element within the image signal processor 202. As shown, the grant_out signals 716A-716N are received into a multiplexer 802. The receiver port 606 uses a select signal 806 to cause the multiplexer 802 to select one of the grant_out signals 716A-716N to be inputted into the receiver FIFO 804. As described above, the host processor 108 configures the image processor 102, wherein output from one processor element in an image signal processor 202 may be input to be processed by a different processor element in a different image signal processor 202 through a logical connection. Accordingly, the host processor 108 causes the receiver port 606 to assert the select signal 806 to select the grant_out signal 716 from the appropriate transmitter port 608/input processor element 302.

As described, the output from a first image process operation in a first image signal processor 202 may be forwarded to a second image signal processor 202, wherein a second image process operation is performed. In an embodiment, this output is transmitted through a logical connection that comprises a number of ports 604 of a number of image signal processors 202. In an embodiment, an initialize signal is transmitted through the different ports 604 through which the data is transmitted for a given logical connection. As described above, the architecture of the image processor 102 is such that a given image signal processor 202 is not directly connected to every other image signal processor 202. Rather, an image signal processor 202 is connected to adjacent (nearest neighbor) devices. Therefore, if data is to be transmitted from one image signal processor 202 to another image signal processor 202, a logical connection is established through different ports of the different image signal processors 202 such that the data traverses from the source image signal processor 202 to the destination image signal processor 202.

Returning to FIG. 2 to illustrate, assume that the output from a processor element within the image signal processor 202C is to be transmitted to a processor element within the image signal processor 202E for further processing. One of a number of logical connections may be established from the image signal processor 202C to the image signal processor 202E. One example of a logical connection is from the image signal processor 202C to the image signal processor 202B to the image signal processor 202A to the image signal processor 202E. A different example of a logical connection is from the image signal processor 202C to the image signal processor 202G to the image signal processor 202F to the image signal processor 202E. In an embodiment, the host processor 108 determines the selection of the logical connection based on the other active logical connections that may be using the same paths of communication. For example, if other logical connections are using the ports between the image signal processor 202B to the image signal processor 202A, the host processor 108 may select the latter example logical connection to reduce the latency for the data processing operations.

In an embodiment, the port 604 from which the data originates is initialized. This initialization signal will be propagated through the entire logical connection, thereby initializing the data path for this given logical connection. This initialization signal is registered and passed through the different ports 604 as if the initialization signal were the data in order to prevent the propagation delays from accumulating through long logical connections. In an embodiment, this initialization may include flushing of the receiver and transmitter FIFOs that are used in the logical connection. Therefore, if any data is within these FIFOs from a previous logical connection, this initialization causes the data to be deleted therefrom. In an embodiment, these different interface signals are handled in this manner to preclude large combinatorial delays through the logical connections. Therefore, routing between the different image signal processors 202 is processed through point-to-point connections that are registered in the different ports 604 that are part of the logical connection.

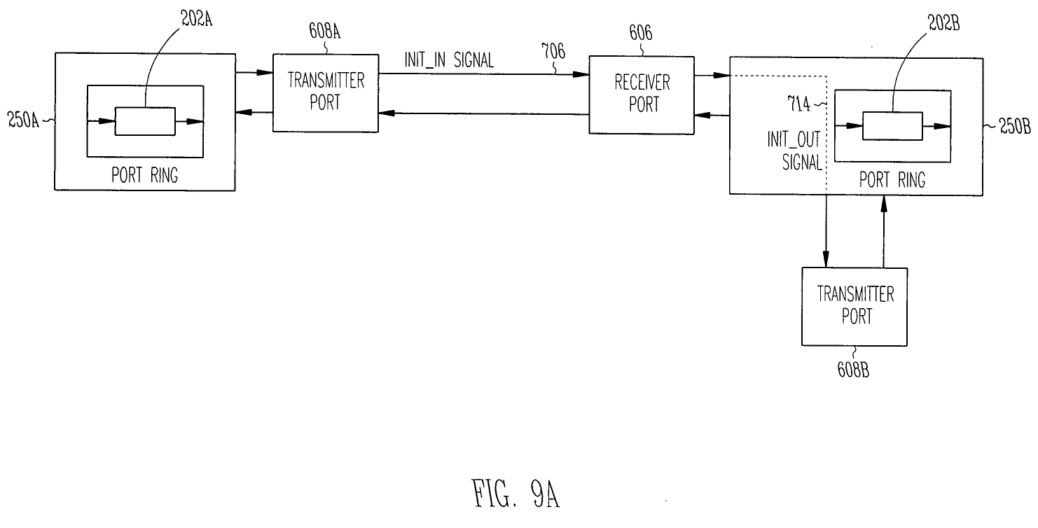

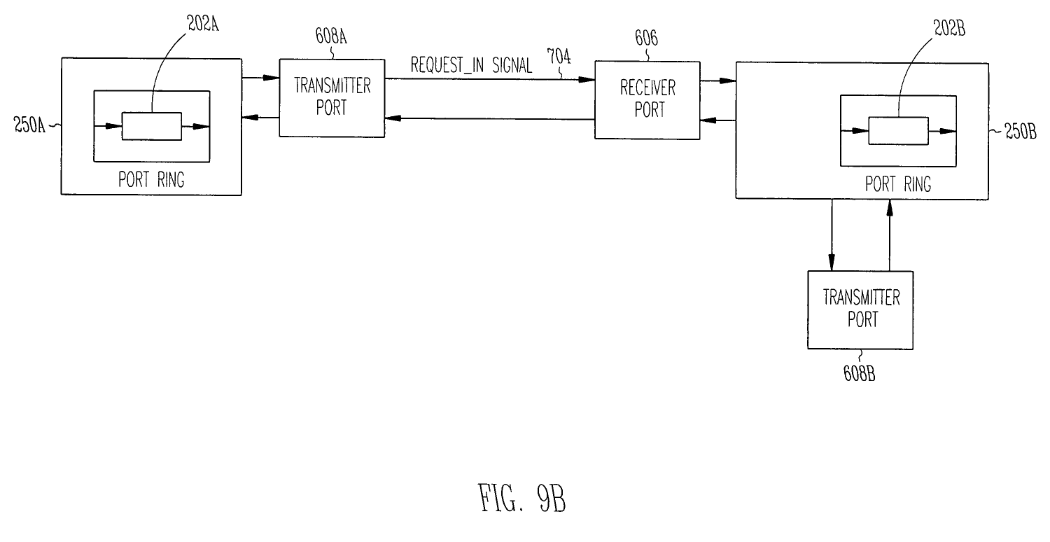

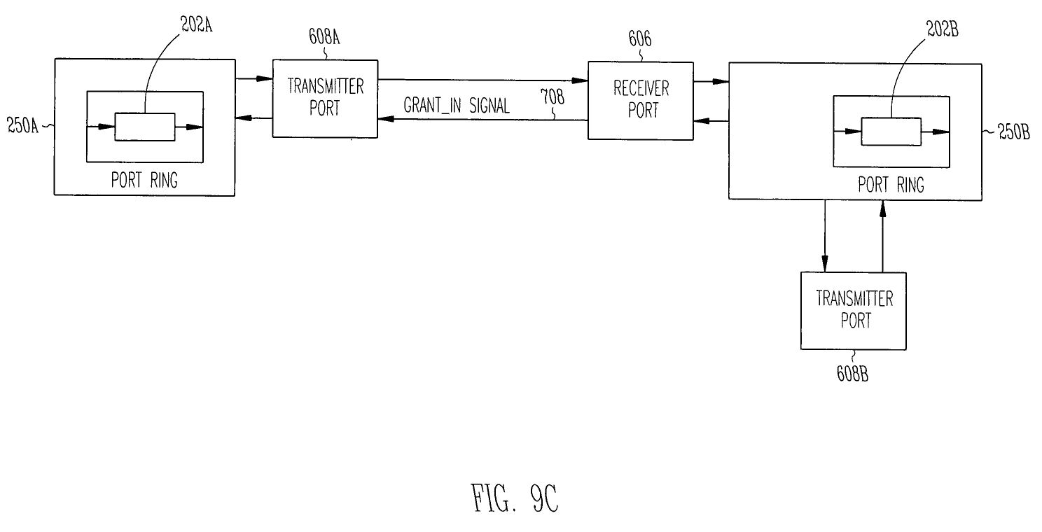

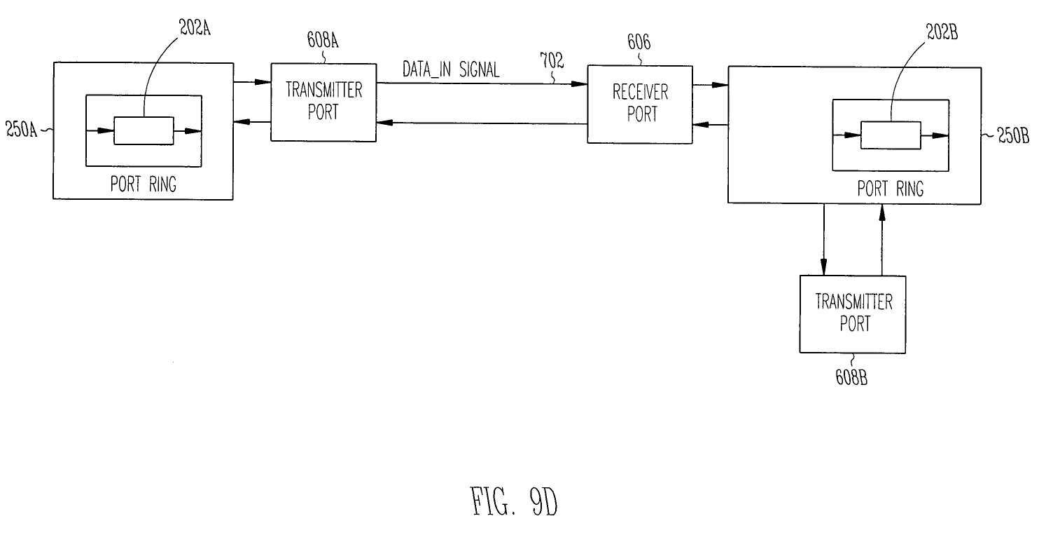

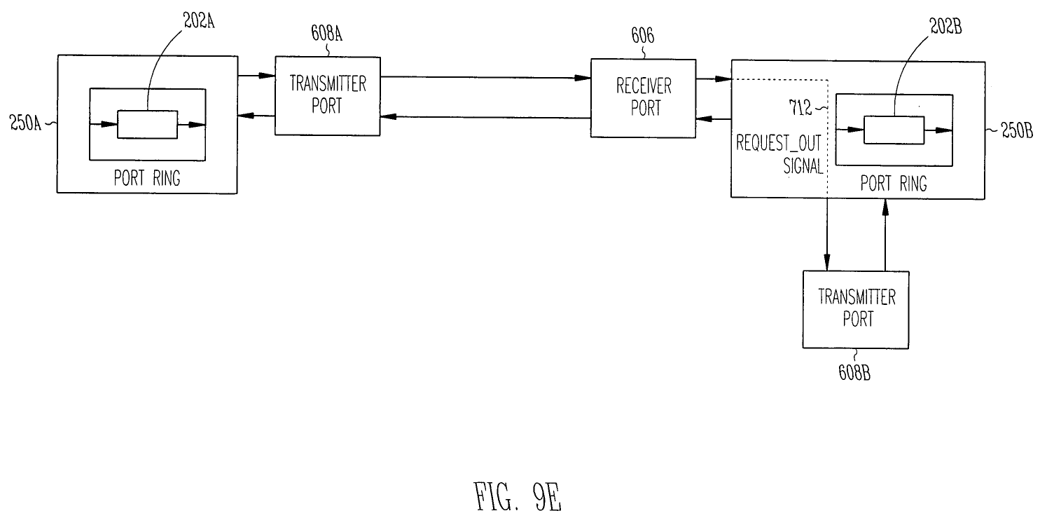

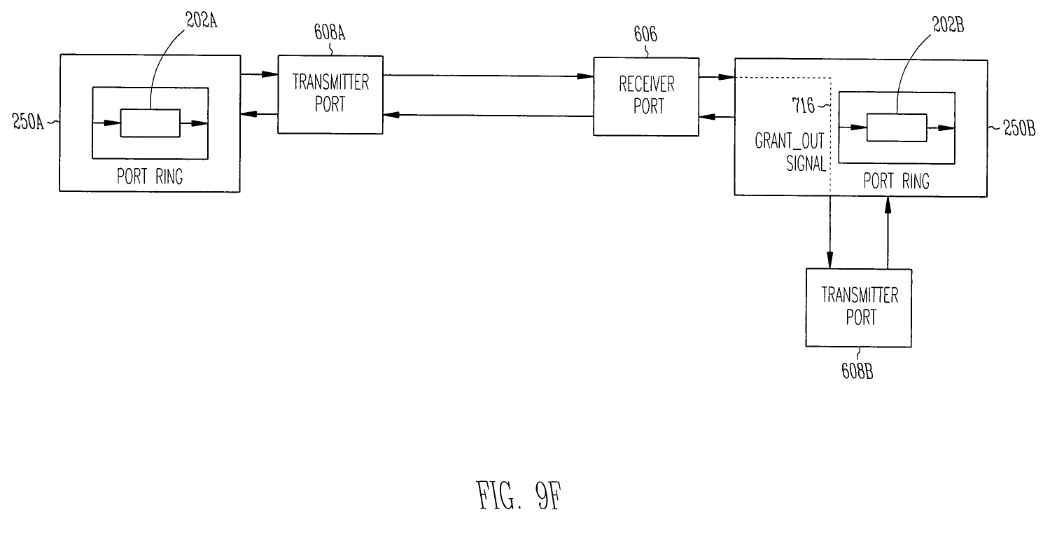

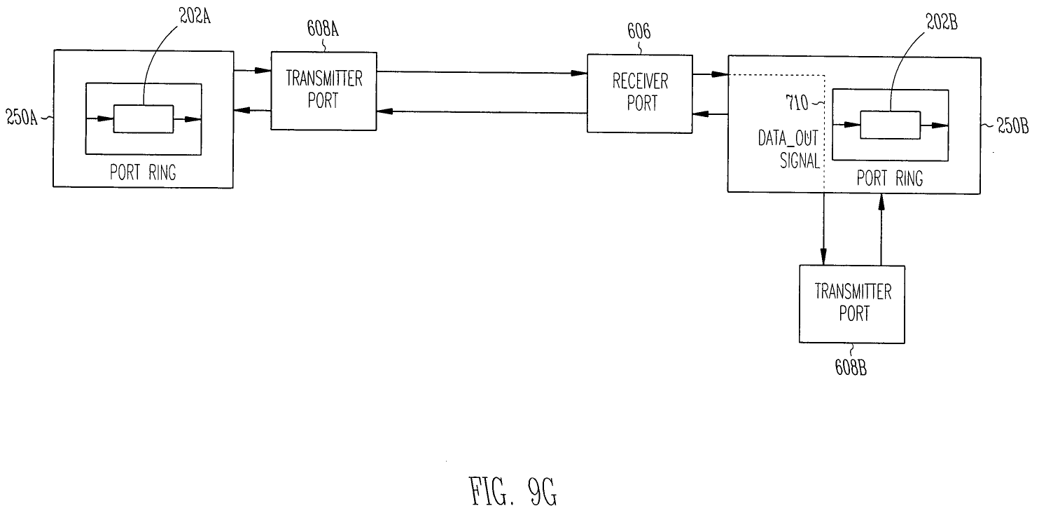

To illustrate, FIGS. 9A-9G illustrate a more detailed block diagram of a receiver port communicating with different transmitter ports, according to some embodiments of the invention. In particular, FIGS. 9A-9D illustrate a more detailed block diagram of the receiver port 606 communicating with the transmitter port 608A that is external to the port ring 250B. FIGS. 9E-9G illustrate a more detailed block diagram of the receiver port 606 communicating with the transmitter port 608B that is internal to the port ring 250B.

FIGS. 9A-9G illustrate the image signal processor 202A and the image signal processor 202B. The image signal processor 202A and the image signal processor 202B include the port ring 250A and the port ring 250B, respectively. Additionally, the image signal processors 202A-202B include a number of receiver and transmitter ports. In particular, a given port 604 (shown in FIG. 6) includes a transmitter port and a receiver port. However, for the sake of clarity, FIGS. 9A-9G illustrate either a transmitter port or receiver port for a given port 604. The port ring 250A of the image signal processor 202A includes the transmitter port 608A. The port ring 250B of the image signal processor 202B includes the receiver port 606 and the transmitter port 608B.

FIG. 9A illustrates that the transmitter port 608A transmits the init_in signal 706 to the receiver port 606 to flush the FIFOs that are part of the logical connection (between itself and the receiver port 606). Furthermore, FIG. 9A illustrates that the receiver port 606 forwards this initialization through the logical connection, as the init_out signal 714 to the transmitter port 608B through the port ring 250B. Accordingly, part of the logical connection includes the transmitter port 608A, the receiver port 606 and the transmitter port 608B. This logical connection may include a number of other image signal processors 202. Therefore, this initialization may have been received by the transmitter port 608A from a different image signal processor 202 through one of the internal receiver ports 606 of the port ring 250A. Additionally, the transmitter port 608B may forward this initialization to another image signal processor 202. Once the initialization of the logical connection is complete, data may be transmitted through this logical connection.

FIG. 9B illustrates that the transmitter port 608A uses the request_in signal 704 to request the inputting of data into the receiver port 606. FIG. 9C illustrates that, in response to the request_in signal 704, and after storage is available in the receiver FIFO 804 of the receiver port 606, the receiver port 606 uses the grant_in signal 708 to indicate to the transmitter port 608A that the transmitter port 608A may transmit data into the receiver port 606. FIG. 9D illustrates that the transmitter port 608A uses the data_in signal 702 to transmit data for storage into the receiver FIFO 804 of the receiver port 606 when the request_in signal 704 and the grant_in signal 716 are active on the active edge of the clock signal controlling the image processor 102.

Additionally as shown in FIG. 8, the receiver port 606 transmits and receives interface signals from a transmitter port 608B which is both part of a same port ring 250. FIGS. 9E-9G illustrate such communications.

FIG. 9E illustrates that the receiver port 606 uses the request_out signal 712 to request the inputting of data into the transmitter port 608B (one of the internal transmitter ports of the port ring 250B). FIG. 9F illustrates that, in response to the request_out signal 712, the transmitter port 608B transmits the grant_out signal 716 back to the receiver port 606. FIG. 9G illustrates that the receiver port 606 uses the data_out signal 710 to transmit the data to the transmitter port 608B when the request_out signal 712 and the grant_out signal 716 are active on the active edge of the clock signal controlling the image processor 102.

Furthermore, although not shown in FIGS. 9E-9G, the receiver port 606 may transmit/receive these interfaces signals (the request_out signal 712, the grant_out signal 716 and the data_out signal 710) to/from the input processor element 302 (illustrated within FIG. 3) for the image signal processor 202B. If the data within the receiver FIFO 804 is to be inputted to one of the processor elements (the input processor element 302, the output processor element 304 and/or the processor elements 306A-306C) within this image signal processor 202 for processing therein, the receiver port 606 transmits the request_out signal 712 to the input processor element 302. If the data within the receiver port 606 is to be transmitted to a device external to the image signal processor 202 (e.g., a different image signal processor 202, one of the DMA units 204 or one of the external interfaces 208), the receiver port 606 transmits the request_out signal 712 to the appropriate transmitter port 608 (the port that is part of the logical connection).

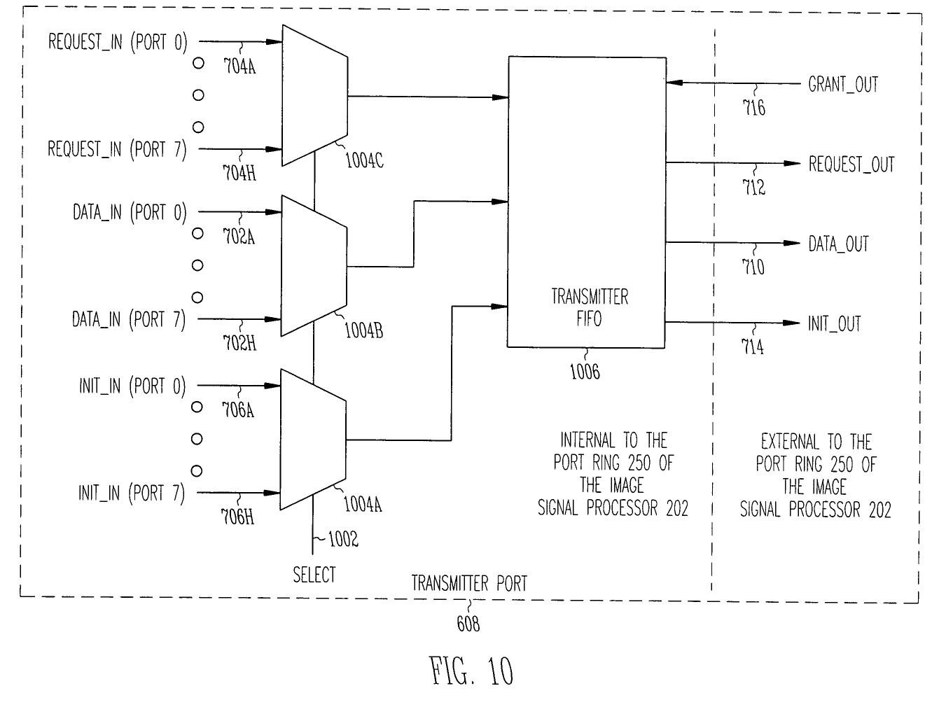

FIG. 10 illustrates a more detailed block diagram of a transmitter port along with associated interface signals, according to some embodiments of the invention. In particular, FIG. 10 illustrates an embodiment of the transmitter port 608 (which includes a transmitter FIFO 1006) and associated interface signals. The transmitter port 608 is within one of the ports 604 (shown in FIG. 6) and is to transmit data out from the image signal processor 202.

As shown, a number of the init_in signals 706A-706H, a number of the data_in signals 702A-702H and a number of the request_in signals 704A-704H are inputted into the transmitter port 608 from one of the receiver ports 606 that are internal to this image signal processor 202 (i.e., that are internal to the port ring 250 of the image signal processor 202). Additionally, the grant_out signal 716, the request_out signal 712, the data_out signal 710 and the init_out signal 714 are outputted from the transmitter port 608 to receiver ports 606 that are external to the port ring 250 for this image signal processor 202.

The transmitter FIFO 1006 is coupled to receive interface signals (the number of the init_in signals 706A-706H, the number of the data_in signals 702A-702H and the number of the request_in signals 704A-704H) through a multiplexer 1004A, a multiplexer 1004B and a multiplexer 1004C, respectively, from a number of receiver ports that are internal to the port ring 250 of the image signal processor 202 or the output processor element 304 (not shown in FIG. 10).

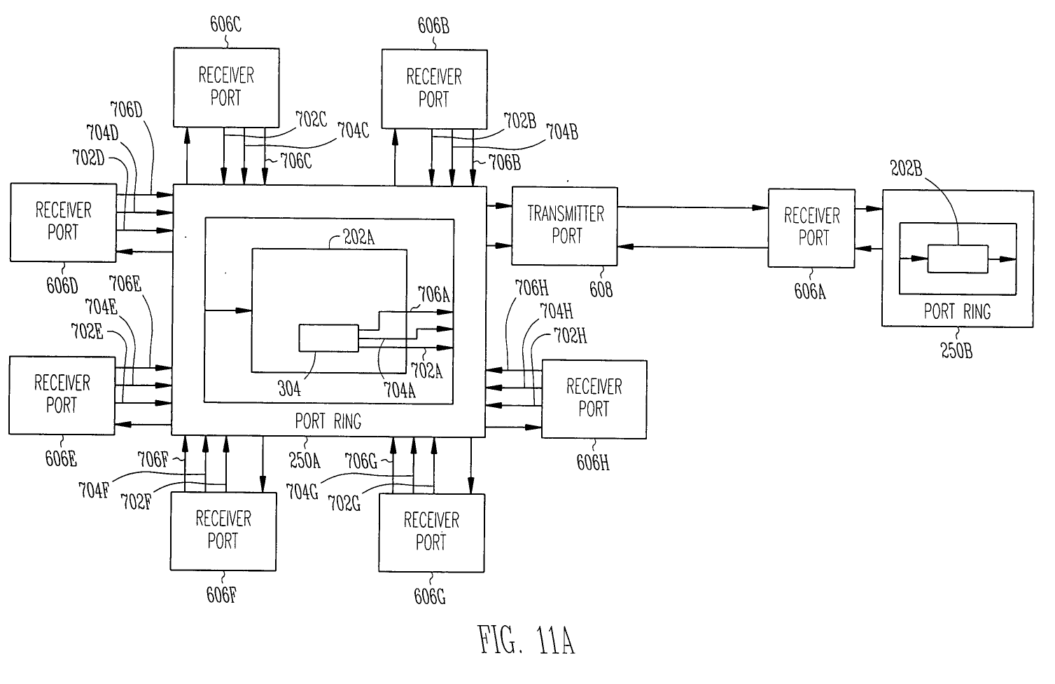

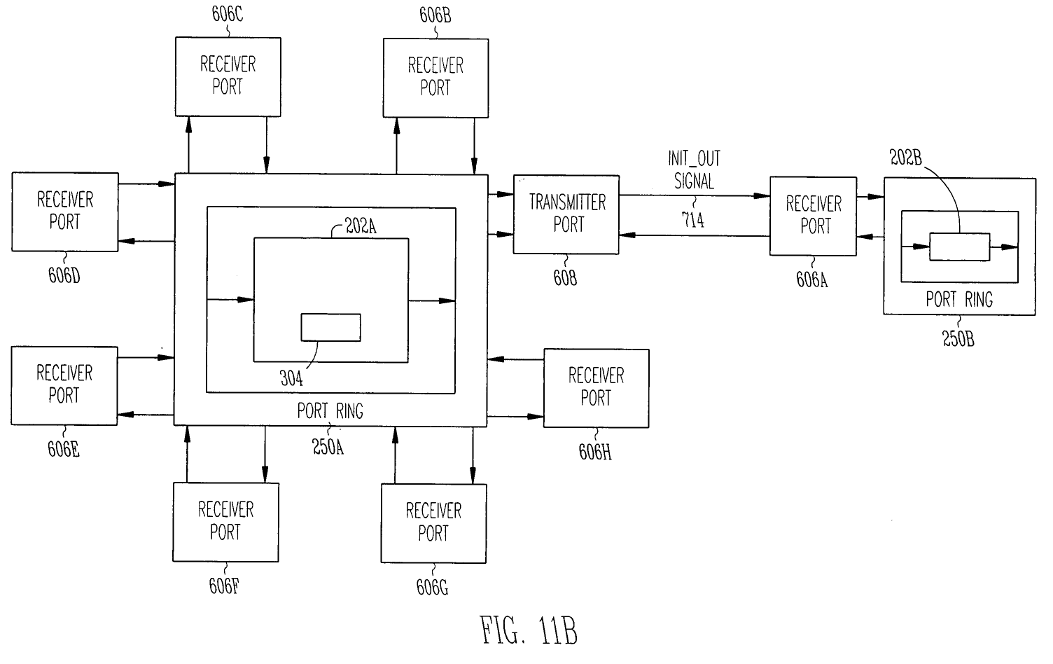

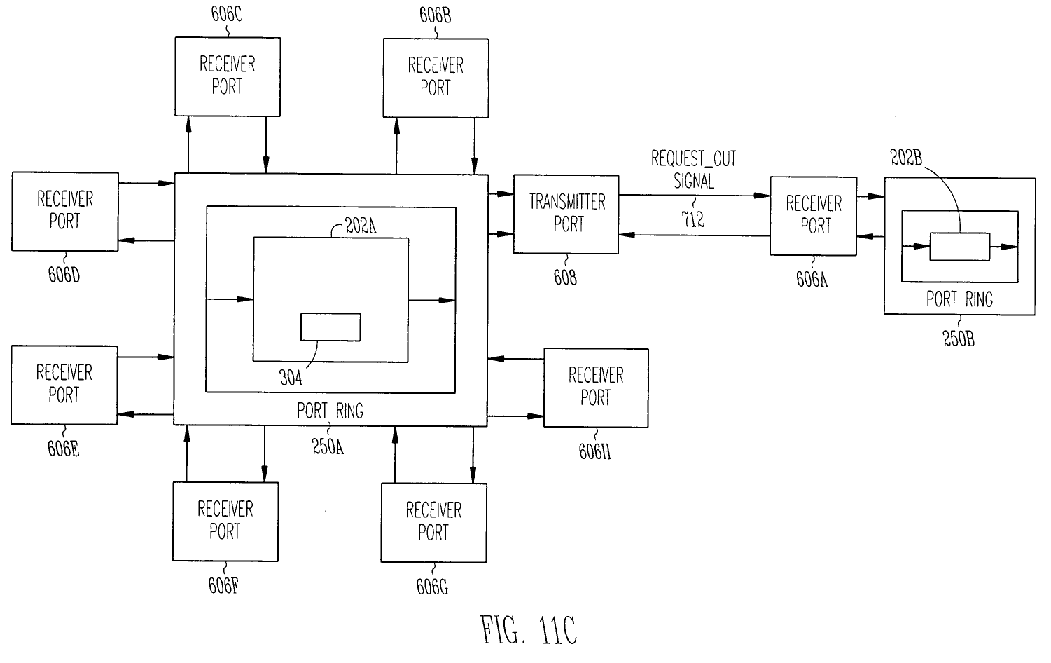

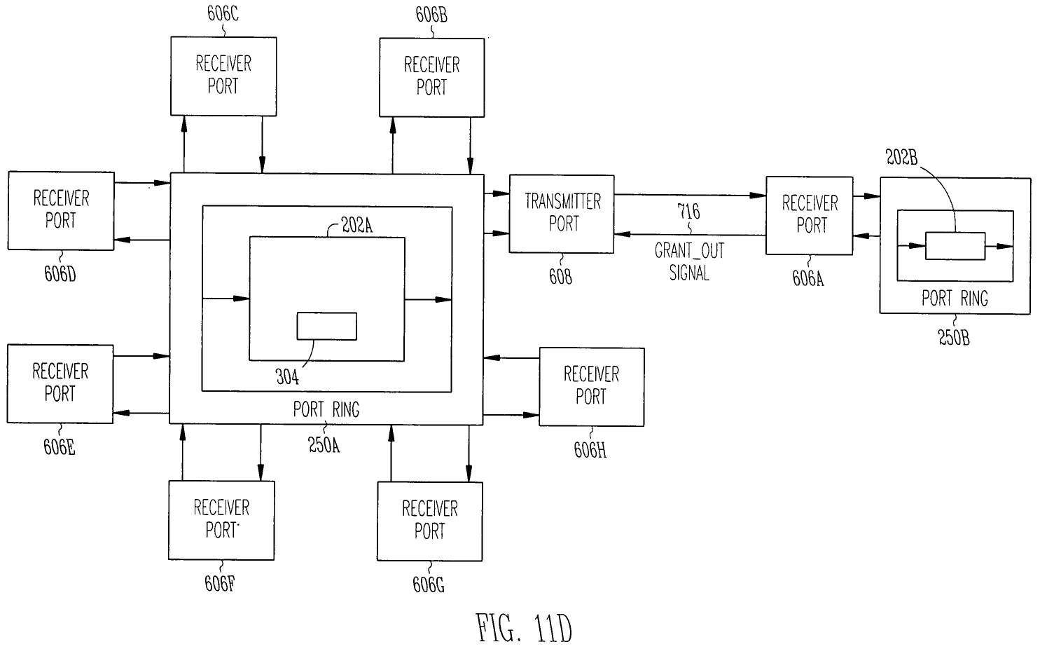

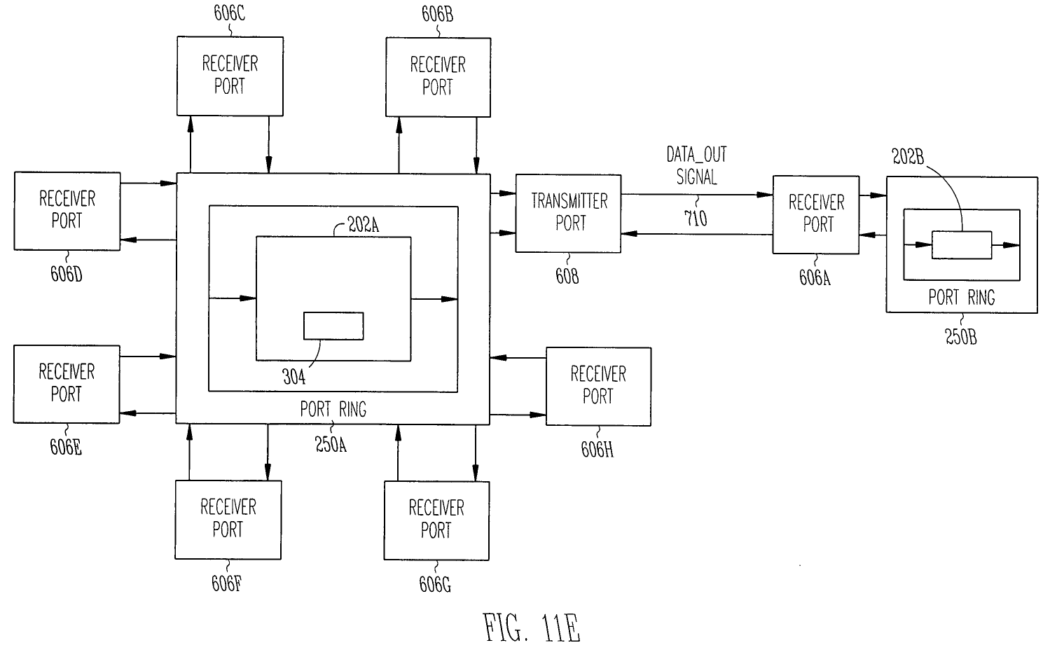

To illustrate, FIGS. 11A-11E illustrate a more detailed block diagram of a transmitter port communicating with different receiver ports that use different interface signals, according to some embodiments of the invention. In particular, FIG. 11A illustrates a more detailed block diagram of the transmitter port 608 receiving interface signals from elements that are internal to the port ring 250 of the image signal processor 202 that the transmitter port 608 is associated. FIGS. 11B-11E illustrate a more detailed block diagram of the transmitter port 608 receiving interface signals from a receiver port 606 that is external to the port ring 250 of the image signal processor 202 that the transmitter port 608 is associated.

FIGS. 11A-11E illustrate the image signal processor 202A and the image signal processor 202B. The image signal processor 202A and the image signal processor 202B include the port ring 250A and the port ring 250B, respectively. Additionally, the image signal processors 202A-202B include a number of receiver and transmitter ports. In particular, a given port 604 (shown in FIG. 6) includes a transmitter port and a receiver port. However, for the sake of clarity, FIGS. 11A-11E illustrate either a transmitter port or receiver port for a given port 604. The port ring 250A of the image signal processor 202A includes the receiver ports 606B-606H and the transmitter port 608. The port ring 250B of the image signal processor 202B includes the receiver port 606A.

With regard to FIG. 11A, the output processor element 304 (within the image signal processor 202A) is coupled to transmit the init_in signal 706A, the data_in signal 702A and the request_in signal 704A. The receiver port 606B transmits the init_in signal 706B, the data_in signal 702B and the request_in signal 704B. The receiver port 606C transmits the init_in signal 706C, the data_in signal 702C and the request_in signal 704C. The receiver port 606D transmits the init_in signal 706D, the data_in signal 702D and the request_in signal 704D. The receiver port 606E transmits the init_in signal 706E, the data_in signal 702E and the request_in signal 704E. The receiver port 606F transmits the init_in signal 706F, the data_in signal 702F and the request_in signal 704F. The receiver port 606G transmits the init_in signal 706G, the data_in signal 702G and the request_in signal 704G. The receiver port 606H transmits the init_in signal 706H, the data_in signal 702H and the request_in signal 704H.

With regard to FIG. 10, the transmitter FIFO 1006 within the transmitter port 608 uses a select signal 1002 to cause the multiplexers 1004A-1004C to select one of the init_in signals 706, one of the data_in signals 702 and one of the request_in signals 704. As described above, the host processor 108 configures the image processor 102, wherein output from one processor element in an image signal processor 202 may be input to be processed by a different processor element in a different image signal processor 202 through a logical connection. Accordingly, the host processor 108 causes the transmitter FIFO 1006 to assert the select signal 1002 to select the init_in signal 706, the data_in signal 702 and the request_in signal 704 from the appropriate source. Returning to FIG. 2 to help illustrate, if a receiver port receives data into the image signal processor 202B and is to output the data through a transmitter port 608 in the image signal processor 202B to a receiver port in the image signal processor 202A, the host processor 108 would configure this transmitter port 608 to select signal 806 from this receiver port.

Accordingly, the selected receiver port 606 (or the selected output processor element 304) uses the init_in signal 706 to initialize the logical connection. In an embodiment, this initialization may include flushing of the receiver and transmitter FIFOs in the ports that are used in the logical connection. Therefore, if any data is within these FIFOs (prior to this initialization), this initialization causes the data to be deleted therefrom. Additionally, the selected receiver port 606 (or the selected output processor element 304) uses the request_in signal 704 to request the input of data into the transmitter FIFO 1006 for the transmitter port 608. The selected receiver port 606 (or the selected output processor element 304) uses data_in signal 702 to transmit data into the transmitter FIFO 1006.

Additionally as shown in FIG. 10, the transmitter port 608 transmits and receives interface signals from the receiver port 606A of a different image signal processor 202 (the image signal processor 202B). FIGS. 11B-11E illustrate such communications.

FIG. 11B illustrates that the transmitter port 608 outputs the init_out signal 714 to the receiver port 606A to which it is attached to generate the logical connection prior to the transmission of data (as described above). FIG. 11C illustrates that the transmitter port 608 outputs the request_out signal 712 to request the inputting of data into the receiver FIFO of the receiver port 606A. FIG. 11D illustrates that, in response, after space is available in the receiver FIFO of the receiver port 606A, the receiver port 606A outputs the grant_out signal 716 that is received by the transmitter port 608. FIG. 11E illustrates that, in response, the transmitter port 608 outputs data from the transmitter FIFO 1006 to the receiver FIFO of the receiver port 606A using the data_out signal 710.

### Logical Connections

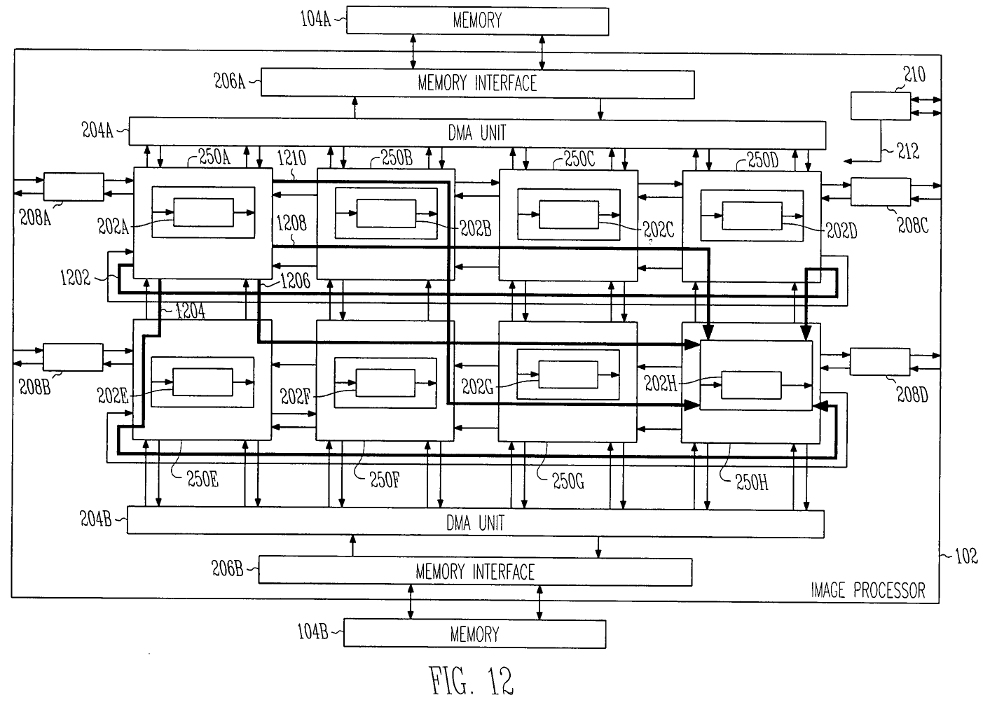

FIG. 12 illustrates a number of different routes for a given logical connection from a source image signal processor to a destination image signal processor, according to some embodiments of the invention. As described above, the host processor 108 can establish a number of logical connections for the transmission of data from a source image signal processor 202 to a destination image signal processor 202. In particular, the output of one image processing operation by an element in a first image signal processor 202 may be used as input for a different image processing operation by an element in a second image signal processor 202.

For example, the first image signal processor 202 may convert the digitized scanned data into a sub-sampled color space, while the second image signal processor 202 receives the converted data and filters such data in order to separate data that is part of a pictorial image from data that is part of text. The second image signal processor 202 transmits the data that is part of the pictorial image to a third image signal processor 202 for further processing. The second image signal processor 202 transmits the data that is part of text to a fourth image signal processor 202 for further processing. In an embodiment, different image signal processors 202 perform different data operations, because (as described in more detail below) one image signal processor 202 may have dedicated hardware accelerators for performing a given operation.

Moreover, while this example illustrates the output of an operation in one image signal processor 202 being transmitted directly to a different image signal processor 202, embodiments of the invention are not so limited. In an embodiment, one image signal processor 202 may transmit the output of an operation to one of the memories 104. Accordingly, a second image signal processor 202 may retrieve the stored data from the memory 104. Such operations may be used when the second image signal processor 202 may require a certain amount of the output from the first operation prior to its operations. For example, the first image signal processor 202 may convert the pixels of an image from left to right along a line, for each line in the image. The second image signal processor 202 may perform an operation that requires the first eight pixels from the first eight lines. Accordingly, the output from the first image signal processor 202 is stored in one of the memories 104 until at least the first eight pixels in the first eight lines have been processed. Continuing with this example, the first image signal processor 202 may continue to convert the data, while, simultaneously, the second image signal processor 202 may perform the filter operation on the data (as described above).

Because the architecture of the processors has a point-to-point configuration (as illustrated in FIG. 2), the first image signal processor 202 may not be directly connected to the second image signal processor 202. Therefore, a logical connection from the first image signal processor 202 (the source image signal processor 202) to the second image signal processor 202 (the destination image signal processor 202) through one to a number of intermediate image signal processors 202 is established.

FIG. 12 illustrates the image processor 102 of FIG. 2, along with five different routes for a given logical connection from the image signal processor 202A to the image signal processor 202H.

A first route 1202 for a logical connection starts at the image signal processor 202A (the source image signal processor) and goes through the port ring 250D of the image signal processor 202D (a first intermediate image signal processor) and completes at the port ring 250H of the image signal processor 202H (the destination image signal processor). In particular, the data is transmitted from a transmitter port of the port ring 250A of the image signal processor 202A to a receiver port of the port ring 250E of the image signal processor 202D. The receiver port of the port ring 250D of the image signal processor 202D transmits the data to a transmitter port of the port ring 250D of the image signal processor 202D (through the port ring 250D of the image signal processor 202D). This transmitter port of the port ring 250D of the image signal processor 202D transmits the data to a receiver port of the port ring 250H of the image signal processor 202H.

A second route 1204 for a logical connection starts at the image signal processor 202A (the source image signal processor) and goes through the image signal processor 202E (a first intermediate image signal processor) and completes at the image signal processor 202H (the destination image signal processor). In particular, the data is transmitted from a transmitter port of the port ring 250A of the image signal processor 202A to a receiver port of the port ring 250E of the image signal processor 202E. The receiver port of the port ring 250E of the image signal processor 202E transmits the data to a transmitter port of the port ring 250E of the image signal processor 202E (through the port ring 250E of the image signal processor 202E). This transmitter port of the port ring 250E of the image signal processor 202E transmits the data to a receiver port of the port ring 250H of the image signal processor 202H.

A third route 1206 for the logical connection starts at the image signal processor 202A (the source image signal processor) and goes through the image signal processor 202E (a first intermediate image signal processor) through the image signal processor 202F (a second intermediate image signal processor) through the image signal processor 202G (a third intermediate image signal processor) and completes at the image signal processor 202H (the destination image signal processor). In particular, the data is transmitted from a transmitter port of the port ring 250A of the image signal processor 202A to a receiver port of the port ring 250E of the image signal processor 202E. The receiver port of the port ring 250E of the image signal processor 202E transmits the data to a transmitter port of the port ring 250E of the image signal processor 202E (through the port ring 250E of the image signal processor 202E). This transmitter port of the port ring 250E of the image signal processor 202E transmits the data to a receiver port of the port ring 250F of the image signal processor 202F. The receiver port of the port ring 250F of the image signal processor 202F transmits the data to a transmitter port of the port ring 250F of the image signal processor 202F (through the port ring 250F of the image signal processor 202F). This transmitter port of the port ring 250F of the image signal processor 202F transmits the data to a receiver port of the port ring 250G of the image signal processor 202G. The receiver port of the port ring 250G of the image signal processor 202G transmits the data to a transmitter port of the port ring 250G of the image signal processor 202G (through the port ring 250G of the image signal processor 202G). This transmitter port of the port ring 250G of the image signal processor 202G transmits the data to a receiver port of the port ring 250H of the image signal processor 202H.

A fourth route 1208 for the logical connection starts at the image signal processor 202A (the source image signal processor) and goes through the image signal processor 202B (a first intermediate image signal processor) through the image signal processor 202C (a second intermediate image signal processor) through the image signal processor 202D (a third intermediate image signal processor) and completes at the image signal processor 202H (the destination image signal processor). In particular, the data is transmitted from a transmitter port of the port ring 250A of the image signal processor 202A to a receiver port of the port ring 250B of the image signal processor 202B. The receiver port of the port ring 250B of the image signal processor 202B transmits the data to a transmitter port of the port ring 250B of the image signal processor 202B (through the port ring 250B of the image signal processor 202B). This transmitter port of the port ring 250B of the image signal processor 202B transmits the data to a receiver port of the port ring 250C of the image signal processor 202C. The receiver port of the port ring 250C of the image signal processor 202C transmits the data to a transmitter port of the port ring 250C of the image signal processor 202C (through the port ring 250C of the image signal processor 202C). This transmitter port of the port ring 250C of the image signal processor 202C transmits the data to a receiver port of the port ring 250D of the image signal processor 202D. The receiver port of the port ring 250D of the image signal processor 202D transmits the data to a transmitter port of the port ring 250D of the image signal processor 202D (through the port ring 250D of the image signal processor 202D). This transmitter port of the port ring 250D of the image signal processor 202D transmits the data to a receiver port of the port ring 250H of the image signal processor 202H.

A fifth route 1210 for the logical connection starts at the image signal processor 202A (the source image signal processor) and goes through the image signal processor 202B (a first intermediate image signal processor) through the image signal processor 202F (a second intermediate image signal processor) through the image signal processor 202G (a third intermediate image signal processor) and completes at the image signal processor 202H (the destination image signal processor). Accordingly, as shown, one to a number of different routes can be used to establish a logical connection between two different image signal processors 202. In particular, the data is transmitted from a transmitter port of the port ring 250A of the image signal processor 202A to a receiver port of the port ring 250B of the image signal processor 202B. The receiver port of the port ring 250B of the image signal processor 202B transmits the data to a transmitter port of the port ring 250B of the image signal processor 202B (through the port ring 250B of the image signal processor 202B). This transmitter port of the port ring 250B of the image signal processor 202B transmits the data to a receiver port of the port ring 250F of the image signal processor 202F. The receiver port of the port ring 250F of the image signal processor 202F transmits the data to a transmitter port of the port ring 250F of the image signal processor 202F (through the port ring 250F of the image signal processor 202F). This transmitter port of the port ring 250F of the image signal processor 202F transmits the data to a receiver port of the port ring 250G of the image signal processor 202G. The receiver port of the port ring 250G of the image signal processor 202G transmits the data to a transmitter port of the port ring 250G of the image signal processor 202G (through the port ring 250G of the image signal processor 202G). This transmitter port of the port ring 250G of the image signal processor 202G transmits the data to a receiver port of the port ring 250H of the image signal processor 202H.

As described, the traversal through an intermediate image signal processor 202 is through the ports 604 of the port ring 250 and not through processor elements or other components internal to the image signal processor 202. Therefore, the processor elements within an intermediate image signal processor 202 do not perform any type of operation on data that is transmitted from the source image signal processor 202 and the destination image signal processor 202.

Therefore, this architecture uses a combination of hardwired point-to-point connections that are configurable. A transmitter port is connected to a predefined destination, which allows for simple and direct wiring of the die of the image processor 102. However, a given transmitter port can select one of several sources for the transmitted data. In turn, a receiver port makes its data available to a number of transmitter ports. This architecture allows for efficient routing of data and control within the port ring 250 for an image signal processor 202. Moreover, passing the initialize signal through a logical connection allows for single-point clearing of the logical path that the data is to traverse at the source of the data and ensure that the intermediate connections do not need to be cleaned up or emptied before or after data transfers. Moreover, logical connections that transfer an indeterminate amount of data and get backed up or stalled can be cleared out with a single command beginning at the source and traversing the logical connection.

### Operations of an Image Processor

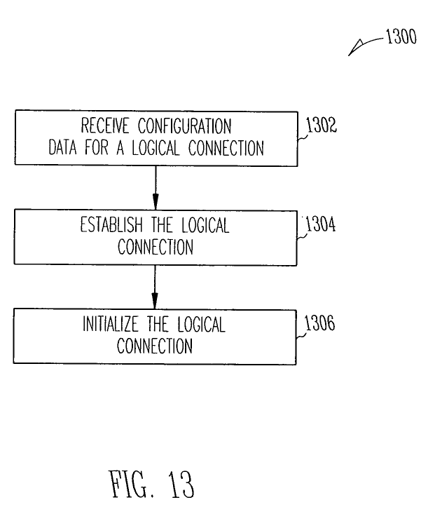

FIG. 13 illustrates a flow diagram for establishing and initializing of a logical connection within an image processor, according to an embodiment of the invention.

In block 1302, configuration data for a logical connection to be established for transmission of data is received. With reference to FIG. 2, the different image signal processors 202 (the source image signal processor, the intermediate image signal processor(s) and the destination image signal processor) receive the configuration data for a logical connection to be established for transmission of data. In an embodiment, the host processor 108 transmits this configuration data to these image signal processors 202 through the internal global bus 212. In an embodiment, the host processor 108 may also download microcode into the image signal processors 202 that are part of the logical connection. For example, the host processor 108 may download a specific application into the source and/or destination image signal processor 202. Control continues at block 1304.

In block 1304, the logical connection is established. With reference to FIGS. 8 and 10, the receiver ports 606 and the transmitter ports 608 (through which data is transmitted as part of the logical connection) establish the logical connection based on the configuration data received. As described above, the receiver ports 606 use the select signals 806 to determine which grant_out signal 716 will be selected by multiplexer 802. For example, if the data received into the receiver port 606A is to be outputted to the transmitter port 608D, then the configuration data causes the receiver port 606A to use the select signal 806 to select the grant_out signal 716 associated with the transmitter port 608D. Similarly, the transmitter ports 608 uses the select signals 1002 to determine which of the request_in signal 704, the data_in signal 702 and the init_in signal 706 will be selected by the multiplexer 1004C, the multiplexer 1004B and the multiplexer 1004A, respectively. Control continues at block 1306.

In block 1306, the logical connection is initialized. With reference to FIGS. 2, 8 and 10, the transmitter port 608 for the source image signal processor 202 that is to originate this logical connection transmits the init_out signal 714 to the receiver port 606 of the next source image signal processor 202 involved with this logical connection. This receiver port 606 receives this signal as init_in signal 706 and outputs the init_out signal 714 to the transmitter port within this source image signal processor 202. This transmission of init_out signals 714 and receipt of init_in signals 706 continues along the logical connection until the transmitter port 608 of the destination image signal processor 202 is reached. Accordingly, this initialize signal initializes the different ports involved in the logical connection. In an embodiment, this initialization may include flushing of the receiver and transmitter FIFOs that are used in the logical connection. Therefore, if any data is within these FIFOs from a previous logical connection, this initialization causes the data to be deleted therefrom.

In an embodiment, a series of image process operations are performed/executed by different components in different image signal processors 202 within the image processor 102. The output of a first image process operation is used as input to a second image process operation, etc. As described above, logical connections are established for the transmission of the data to the different image signal processors 202. Therefore, a logical connection is established for each transmission from one element in the image processor 102 to a different element in the image processor 102. An embodiment for the processing of data in the image processor 102 will now be described.

FIG. 14 illustrates a flow diagram for processing of data by an image processor, according to some embodiments of the invention. In particular, the flow diagram 1400 describes the processing of data by one of the image signal processors 202 within the image processor 102, according to an embodiment of the invention.

In block 1402, a stream of data is received. With reference to FIG. 2, a first of the image signal processors 202 receives the stream of data from one of a number of sources. For example, the image signal processor 202A may receive the stream of data from an external source (such as the sensor 116). The image signal processor 202A may also receive the stream of data from the memory 104A through the memory interface 206A and the DMA unit 204A. Control continues at block 1404.

In block 1404, the stream of data is processed in a first image signal processor. With reference to FIG. 2, a component (e.g., one of the processor elements 302, 304, 306A-306C or one of the accelerator units 310A-310B) within the first image signal processor 202 performs a first image process operation. The input processor element 302 receives the data through the receiver port 606. In an embodiment, any of the processor elements 302, 304, 306A-306C performs/executes the image process operation on the received data. In an embodiment, as part of the configuration of the logical connection of which the image process operation is associated, the host processor 108 may indicate which of the components in the first image signal processor 202 is to perform/execute the image process operation. Accordingly, the input processor element 302 may store the data into the memory 314 wherein the designated component retrieves the data and performs/executes the first image process operation on such data. The first image signal processor 202 may output a result for processing a part of the stream of data, while continuing to process a different part of the stream of data. For example, for a scanned image, the first image signal processor 202 may output a result for processing the first eight lines of the scanned image, while continuing to process subsequent lines of the scanned image. Control continues at block 1406.

In block 1406, the output of the image process operation is transmitted/forwarded to a different image signal processor or a memory through a logical connection. With reference to FIGS. 2 and 3, the output processor element 304 (in the image signal processor 202 in which the first image process operation is performed/executed) transmits/forwards the output of the image process operation through a transmitter port 608 that is part of the configured logical connection to a different image signal processor 202 or to one of the memories 104A-104B through the configured logical connection. Control continues at block 1408.

In block 1408, the result is processed in the different image signal processor. Similar to the processing in the first image signal processor (described in block 1404), a component (e.g., one of the processor elements 302, 304, 306A-306C or one of the accelerator units 310A-310B) within the different image signal processor 202 performs a different image process operation. For example, the first image process operation is to convert digitized scanned data into a sub-sampled color space, while the second image process operation is to filter the result of the first image process operation in order to separate data that is part of a pictorial image from data that is part of text. Control continues at block 1410.

In block 1410, a determination is made of whether the process operations for the stream of data are completed. In particular, the current image signal processor 202 that is processing a part of the stream of data determines whether the output of its operations is to be transmitted to a different image signal processor 202 or to one of the memories 104A-104B through a logical connection based on configuration data received from the host processor 108. In particular, the host processor 108 may configure the image processor 102 to receive a stream of data and to perform five different image process operations in five different image signal processors 202. Accordingly, the host processor 108 configures the different logical connections to transmit the data to the five different image signal processors 202 in a given order. Upon determining that the image process operations are not complete for the stream of data, control continues at block 1406 wherein the result of the processing is outputted to a different image signal processor 202 or one of the memories 104A-104B. The operations of block 1406 and 1406 continue until the image process operations are complete for the stream of data.

In block 1412, upon determining that the image process operations are complete for the stream of data, the results are outputted. With reference to FIG. 2, in an embodiment, the final image signal processor 202 in the chain of image signal processors to process the stream of data outputs the result to one of the memories 104A-104B. With reference to FIG. 1, in an embodiment, the final image signal processor 202 outputs the result to an application executing within the host processor 108 or to a secondary storage device (not shown), a monitor (not shown) and/or a printer coupled to the I/O interfaces 110.

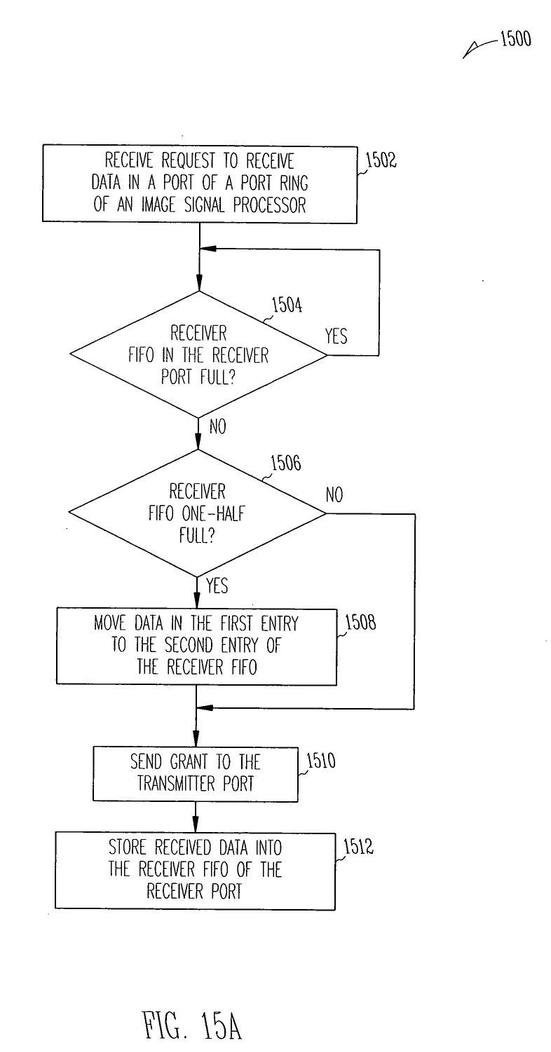

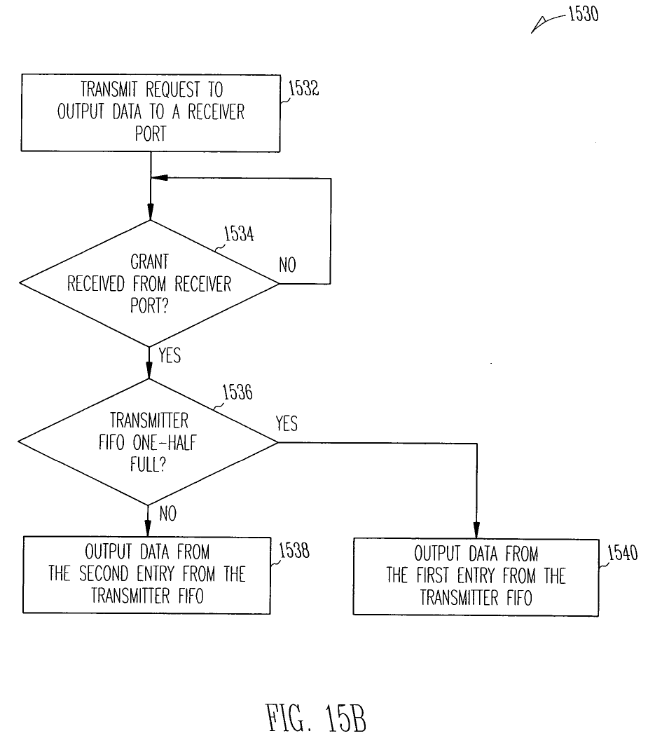

An embodiment of the operations for the transmission of data between different ports of the image signal processors 202 based on a handshake protocol will now be described. In particular, FIGS. 15A-15B illustrate flow diagrams for communications among memories of different ports in an image processor, according to some embodiments of the invention. By way of example and not by way of limitation, the operations of the flow diagrams 1500 and 1530 are described such that the FIFO memories within these different ports have a depth of two (i.e., a two-entry FIFO). FIG. 15A illustrates a flow diagram for receiving data into a memory of a port, while FIG. 15B illustrates a flow diagram for transmitting data out of a memory of a port.

In block 1502, a request to receive data is received into a receiver port of a port ring of an image signal processor. With reference to FIG. 8, the receiver port 606 receives a request to receive data through the request_in signal 704. As described above, a transmitter port 608 that is coupled to the receiver port 606 transmits this request. Control continues at block 1504.

In block 1504, a determination is made of whether the receiver FIFO of the receiver port is full. With reference to FIG. 8, the receiver port 606 determines whether the receiver FIFO 606 is full. Upon determining that the receiver FIFO 804 of the receiver port 606 is full, control continues at block 1504 where this determination is again made. In an embodiment, this request may time out after a predetermined period, wherein an alarm is issued to the host processor 108 and the operation of the flow diagram 1500 is aborted.

In block 1506, upon determining that the receiver FIFO 804 of the receiver port 606 is not full, a determination is made of whether the receiver FIFO is one-half full. As described above, the receiver FIFO 804 is described as having a depth of two. With reference to FIG. 8, the receiver port 606 determines whether the receiver FIFO 804 is one-half full. In other words, the receiver port 606 determines whether the receiver FIFO 804 is empty or has data in one entry. Upon determining that the receiver FIFO is not one-half full (i.e., the receiver FIFO is empty), control continues at block 1510, which is described in more detail below.

In block 1508, upon determining that the receiver FIFO is one-half full, data stored in the first entry in the receiver FIFO is moved to the second entry in the receiver FIFO. With reference to FIG. 8, the receiver port 606 moves the data stored in the first entry to the second entry in the receiver FIFO 804. Control continues at block 1510.

In block 1510, a grant is sent to the requesting transmitter port (the transmitter port requesting to send data to the receiver port). With reference to FIG. 8, the receiver port 606 transmits a grant through the grant_in signal 708 to the transmitter port 608, thereby indicating that the transmitter port 608 may transmit data into the receiver FIFO 804. Control continues at block 1512.

In block 1512, received data is stored into the receiver FIFO of the receiver port. With reference to FIG. 8, the receiver port 606 stores the received data into the first entry of the receiver FIFO 804, which is received from the transmitter port 608 through the data_in signal 702.

An embodiment of transmitting data out of a memory of a port is now described in conjunction with the flow diagram 1530 of FIG. 15B. In block 1532, a request to output data to a receiver port is transmitted. With reference to FIG. 10, the transmitter port 608 transmits the request to output data to the receiver port 606 (to which the transmitter port 608 is coupled) through the request_out signal 712. Control continues at block 1534.

In block 1534, a determination is made of whether a grant has been received from the receiver port. With reference to FIG. 10, the transmitter port 608 determines whether a grant has been received from the receiver port 606 based on the value of the grant_out signal 716. Upon determining that the grant has not been received from the receiver port 606, control continues at block 1534, wherein the transmitter port 608 again makes this determination. In an embodiment, this checking of a grant may time out after a predetermined period, wherein an alarm is issued to the host processor 108, and the operation of the flow diagram 1500 is aborted.

In block 1536, upon determining that the grant has been received from the receiver port, a determination is made of whether the transmitter FIFO is one-half full. With reference to FIG. 10, the transmitter port 608 determines whether the transmitter FIFO 906 is one-half full. Because the operations of the flow diagram 1530 have been initiated, the assumption is that the transmitter FIFO 906 is not empty.

In block 1538, upon determining that the transmitter FIFO is not one-half full (the transmitter FIFO is full), data from the second entry of the transmitter FIFO is outputted to the receiver FIFO. With reference to FIG. 10, the transmitter port 608 outputs the data from the second entry of the transmitter FIFO 906 through the data_out signal 710 to the receiver FIFO, thereby completing the operations of the flow diagram 1530.

In block 1540, upon determining that the transmitter FIFO is one-half full, data from the first entry of the transmitter FIFO is outputted to the receiver FIFO. With reference to FIG. 10, the transmitter port 608 outputs the data from the first entry of the transmitter FIFO 906 through the data_out signal 710 to the receiver FIFO, thereby completing the operations of the flow diagram 1530.

While the flow diagrams 1500 and 1530 describe the communications between receiver and transmitter ports that are part of different port rings, the handshake protocol operations described are also applicable to communications between receiver and transmitter ports that are part of the same port ring. Moreover, such handshake protocol operations are applicable for the inputting and outputting of data into the input processor element 302 and the output processor element 304, respectively.

Accordingly, as described in FIG. 15A-15B, in an embodiment, the data-driven architecture for image process operations is based on this handshake protocol for transmitting data through the different port for logical connections. A “bubble” is a clock period where no data transaction occurred (i.e., data was not moved in the given clock period). For example, data was not ready to be transmitted at the beginning, and/or data was not retrieved at the end of the logical connection. Therefore, there may be an empty place in the logical connection, because data was not put into the logical connection.

Moreover, as described, if a bubble forms in the logical connection because of a data stall condition at the source image signal processor or the destination image signal processor, then data is paused for a single clock period. In other words, the FIFO memories within the receiver and transmitter ports allow for bubbles in the logical connection that do not grow from stopping and restarting of the data flow within the logical connection. Embodiments of the invention are such that a bubble does not force a delay at either end of the logical connection beyond the bubble. The bubble does not require the image processor 102 to resync (which may require more clock periods to recover than the number of clocks periods associated with the bubble itself).

FIG. 16 illustrates a flow diagram for descreening an image, according to some embodiments of the invention. In particular, a flow diagram 1600 illustrates an embodiment of the operations of the components of FIGS. 4 and 5. As further described below, the operations in blocks 1602-1608 may essentially remove a Moiré pattern from an image. Because such operations include the removal of high frequency data (which includes edge data), the operations in block 1610-1616 reintroduce such edge data back into the image.

In block 1602, an image is received. With reference to the embodiments of FIGS. 4 and 5, the lowpass filter 404 and the lowpass filter 406 may receive the image. Referring to FIG. 1, the sensor 116 may scan in an image that is input into the image processor 102. The image may then be routed through a logical connection to one of the image signal processors 202 (as described above). In some embodiments, the image may include a Moiré pattern (introduced by the scanning operation) that is to be removed. Control continues at block 1604.

In block 1604, a first lowpass filter operation at a first filter kernel size is performed. With reference to the embodiments of FIGS. 4 and 5, the lowpass filter 404 may perform the first lowpass filter operation. As described above, the lowpass filter 404 may be configured to perform the lowpass filter operation at different kernel sizes. Control continues at block 1608 (which is described in more detail below).

In block 1606, a second lowpass filter operation at a second filter kernel size is performed. With reference to the embodiments of FIGS. 4 and 5, the lowpass filter 406 may perform this second lowpass filter operation. In some embodiments, the operations in blocks 1604 and block 1606 may be performed simultaneously, at least in part. The first filter kernel size may be the same or different from the second filter kernel size. Control continues at block 1608.

In block 1608, a blended lowpass filtered image is generated based on output from the lowpass filter operations. With reference to the embodiments of FIGS. 4 and 5, the multiplier 408-410 and the adder 410 may generate the blended lowpass filtered image. The multiplier 408 may multiply the output from the lowpass filter 404 by a first percentage. The multiplier 410 may multiply the output from the lowpass filter 406 by a second percentage. The multipliers 408-410 are configured such that the first and second percentages total 100%. For example, if the multiplier 408 multiplies the output from the lowpass filter 404 by 25%, the multiplier 410 multiplies the output from the lowpass filter 406 by 75%. The adder 410 may receive the outputs from the multipliers 408-410 and add the two outputs to generate the blended lowpass filtered image 414. If the image 402 includes a Moiré pattern, the operations described thus far in the flow diagram 1600 have essentially removed this pattern therefrom. Control continues at block 1610.

In block 1610, a third lowpass filter operation at a third filter kernel size is performed on the blended lowpass filtered image. With reference to the embodiments of FIGS. 4 and 5, the lowpass filter 502 may perform this third lowpass filter operation. The third filter kernel size may be the same or different from the first and second kernel sizes. Control continues at block 1612.

In block 1612, the high frequency data is extracted from the output of the third lowpass filter operation. With reference to the embodiments of FIGS. 4 and 5, the subtractor 504 extracts the high frequency data. The subtractor 504 outputs a difference between the blended lowpass filtered image 414 and the output from the lowpass filter 502. This difference may be indicative of the high frequency data. Control continues at block 1614.

In block 1614, the high frequency data is scaled. With reference to the embodiments of FIGS. 4 and 5, the scaler 506 may scale the high frequency data. This scaling may reduce the contrast. In some embodiments, in addition to or alternatively, the high frequency data may be clamped to a given level to reduce the contrast. Control continues at block 1616.

In block 1616, the contrast-reduced high frequency data is added to the blended lowpass filtered image to generate the descreened output image. With reference to the embodiments of FIGS. 4 and 5, the adder 508 may perform this operation. The operations of the flow diagram 1600 are complete.

While the flow diagram 1600 illustrates the output of the first stage of this descreening as a lowpass filtered image that is blended, embodiments of the invention are not so limited. For example, in some embodiments, the output of the first stage may be a lowpass filtered image that is not blended. Accordingly, a single lowpass filter may output a lowpass filtered image (independent of a second lowpass filter, the multipliers and the adder). This lowpass filtered image is essentially without the Moiré pattern that is then inputted into the second stage of the operation (as described above).

### Multi-Image Processor System

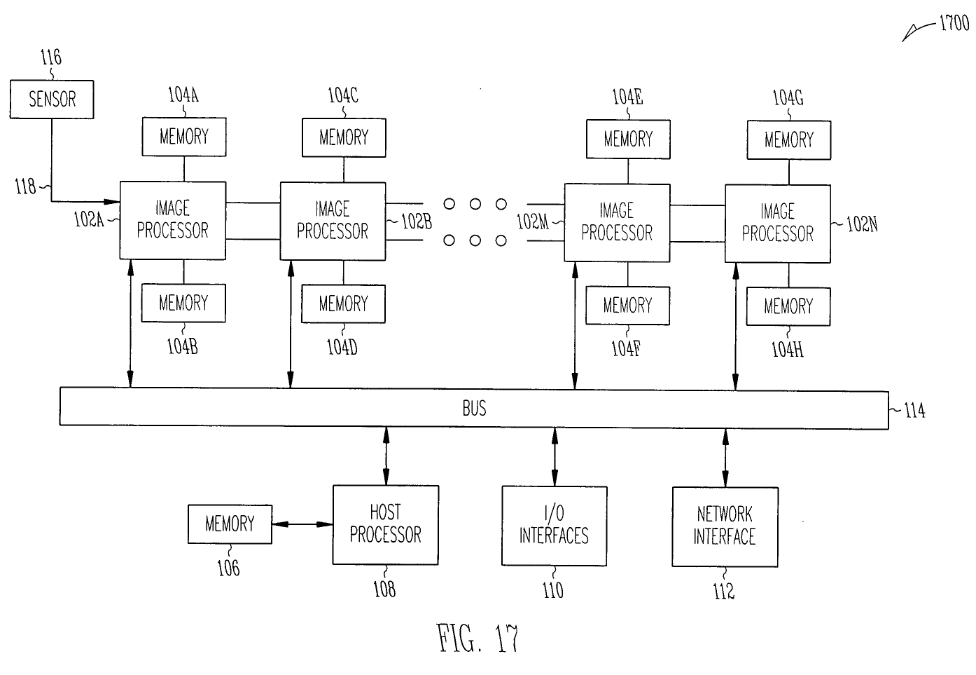

FIG. 17 illustrates a system for a multi-image processor-to-processor communication in a data-driven architecture, according to another embodiment of the invention. In particular, FIG. 17 illustrates a system 1700 that includes the sensor 116, the memory 106, the host processor 108, the I/O interfaces 110 and the network interface 112 (as described above in conjunction with FIG. 1). In contrast to the system 100 of FIG. 1, the system 1700 includes a number of image processors 102A-102N that are coupled together. The image processor 102A is coupled to the image processor 102B. The image processor 102B is coupled to the image processor 102M (possibly through one to a number of other image processors 102). The image processor 102M is coupled to the image processor 102N. In an embodiment, the number of image processors 102A-102N are coupled together through the expansion interfaces 208A-208D (refer to FIG. 2).

Similar to the system 100 of FIG. 1, an image processor 102 is coupled to a number of memories 104. For example, the image processor 102A is coupled to the memories 104A-104B. The image processor 102B is coupled to the memories 104C-104D. The image processor 102M is coupled to the memories 104E-104F. The image processor 102N is coupled to the memories 104G-104H. In an alternative embodiment, the image processors 102A-102N may share one set of memories 104. For example, the image processors 102A-102N may each be coupled to the memories 104A-104B, wherein the image processors 102A-102N may store and retrieve data from a same set of memories.

In an embodiment, the host processor 108 may configure logical connections across different image processors 102A-102N. For example, the output from an image process operation executed in an image signal processor 202 in the image processor 102A may be inputted into an image signal processor 202 in the image processor 102N through the expansion interfaces 208A-208D of the image processor 102A and the image processor 102N based on point-to-point traversing through a number of port rings of different image signal processors 202. Moreover, in an embodiment, the output from an image process operation executed in an image signal processor 202 in the image processor 102A may be stored in one of the memories 104A-104B. Subsequently, an image signal processor 202 in the image processor 102N may retrieve this stored data for execution of an image process operation therein. Therefore, as described, embodiments of the invention provide the ability to scale the number of image signal processors with small variations to the architecture.

In the description, numerous specific details such as logic implementations, opcodes, ways of describing operands, resource partitioning/sharing/duplication implementations, types and interrelationships of system components, and logic partitioning/integration choices are set forth in order to provide a more thorough understanding of the inventive subject matter. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention include features, methods or processes that may be embodied within machine-executable instructions provided by a machine-readable medium. A machine-readable medium includes any mechanism that provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general-purpose or special-purpose processor, programmed with the instructions, to perform methods or processes of the embodiments of the invention. Alternatively, the features or operations of embodiments of the invention are performed by specific hardware components that contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for descreening an image to remove a Moiré pattern, in accordance with embodiments of the invention. A number of figures show flow diagrams illustrating descreening of an image to remove a Moiré pattern, in accordance with embodiments of the invention. The operations of the flow diagrams have been described with reference to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

In view of the wide variety of permutations to the embodiments described herein, this detailed description is intended to be illustrative only, and should not be taken as limiting the scope of the inventive subject matter. What is claimed, therefore, are all such modifications as may come within the scope and spirit of the following claims and equivalents thereto. Therefore, the specification and drawings are to be regarded in an illustrative rather than a restrictive sense.

1. A method comprising:
lowpass filtering an image, with a first lowpass filter that is part of a first hardware accelerator within an image signal processor, to generate a first lowpass filtered image;
lowpass filtering, with a second lowpass filter that is part of a second hardware accelerator within the image signal processor, the first lowpass filtered image to generate a second lowpass filtered image;
extracting high frequency data from the first lowpass filtered image; and
combining the high frequency data with the first lowpass filtered image.

2. The method of claim 1, wherein lowpass filtering the image comprises lowpass filtering a half-tone image.

3. The method of claim 1, wherein lowpass filtering the image with the first lowpass filter comprises lowpass filtering the image with a single triangular filter.

4. The method of claim 3, wherein lowpass filtering with the second lowpass filter comprises lowpass filtering with a variable triangular filter.

5. The method of claim 1, further comprising scaling the high frequency data prior to adding the high frequency data to the first lowpass filtered image.

6. The method of claim 1, further comprising transmitting the image from an interface coupled to a sensor to the image signal processor through a logical connection that includes a port ring of at least one other image signal processor.

7. A method comprising:
performing at least two lowpass filter operations on an image in at least two different hardware accelerators within an image processor that includes a processor-to-processor communication in a data-driven architecture;
extracting high frequency data from an output of a first lowpass filter operation of the at least two lowpass filter operations;
generating a descreened image based on the high frequency data and an output of the first lowpass filter operation of the at least two lowpass filter operations.

8. The method of claim 7, wherein performing at least two lowpass filter operations in at least two different hardware accelerators the image processor comprises:
performing a first lowpass filter operation in a first hardware accelerator within a first image signal processor of the image processor;
transmitting, through a second image signal processor of the image processor, the output of the first lowpass filter operation to a third image signal processor of the image processor, wherein no processor element in the second image signal processor is to perform a process operation on the output as part of the transmission of the data from the first image signal processor to the third image signal processor; and
performing a second lowpass filter operation in a second hardware accelerator within the second image signal processor.

9. The method of claim 8, wherein performing the first lowpass filter operation in the first hardware accelerator within the first image signal processor comprises performing the first lowpass filter operation with a variable triangular filter in the first hardware accelerator.

10. The method of claim 8, wherein performing the second lowpass filter operation in the second hardware accelerator within the second image signal processor comprises performing the second lowpass filter operation with a variable triangular filter in the second hardware accelerator.

11. The method of claim 7, wherein performing at least two lowpass filter operations on an image comprises performing at least two lowpass filter operations on a half-tone image.

12. The method of claim 7, further comprising scaling the high frequency data prior to the addition of the high frequency data to the output of the first lowpass filter operation.

13. A method comprising:
removing substantially a Moiré pattern from an image based on a blending of at least two lowpass filter operations in an accelerator of a first image signal processor;
transmitting the image from the first image signal processor to a second image signal processor through a logical connection that includes a number of ports of a number of other different image signal processors; and
combining high frequency data to the image using components of the second image signal processor.

14. The method of claim 13, wherein combining adding the high frequency data back to the image using components of the second image signal processor comprises:
performing a lowpass filter operation of the image received from the first image signal processor; and
extracting the high frequency data from the image received from the first image signal processor based on a difference between an output of the lowpass filter operation and the image received from the first image signal processor.

15. The method of claim 13, further comprising scaling the high frequency data prior to combining the high frequency data back to the image using one of the components of the second image signal processor.

16. The method of claim 13, wherein removing substantially the Moiré pattern from the image based on the blending of at least two lowpass filter operations in accelerators of the first image signal processor comprises:
performing a first lowpass filter operation of the at least two lowpass filter operations using a variable triangular filter in the accelerator based on a first filter kernel size;
performing a second lowpass filter operation of the at least two lowpass filter operations using the variable triangular filter in the accelerator based on a second filter kernel size; and
blending an output of the first lowpass filter operation with an output of the second lowpass filter operation.

17. An apparatus comprising:
a first image signal processor that includes a first hardware accelerator to perform a first lowpass filter operation to generate a first lowpass filtered image; and
a second image signal processor to receive the first lowpass filtered image through a logical connection that includes transmission through a port ring of a third image signal processor, wherein the second image signal processor includes a second hardware accelerator to perform a second lowpass filter operation on the first lowpass filtered image to generate a second lowpass filtered image.

18. The apparatus of claim 17, wherein the first image signal processor or the second image signal processor includes a first processor element to extract high frequency data from the second lowpass filtered image, wherein the first image signal processor or the second image signal processor includes a second processor element to add the high frequency data to the second lowpass filtered image.

19. The apparatus of claim 17, wherein no processor element within the third image signal processor is to perform a process operation on the first lowpass filtered image as part of the transmission of the first lowpass filtered image from the first image signal processor to the second image signal processor through the logical connection.

20. The apparatus of claim 17, wherein the first image signal processor, the second image signal processor and the third image signal processor are coupled together in a point-to-point configuration.

21. A system comprising:
a charge-coupled device sensor to capture an image;
an image processor that includes a number of processors coupled together in a point-to-point configuration, wherein a first processor of the number of processors includes a first hardware accelerator to perform a first portion of a descreen operation on the image, and wherein a second processor includes a second hardware accelerator to perform a second.

22. The system of claim 21, wherein the first hardware accelerator is to perform the first descreen operation and a second descreen operation with a variable triangular filter, wherein the variable triangular filter is to perform the first descreen operation based on a first filter kernel size and is to perform the second descreen operation based on a second filter kernel size, and wherein the first kernel size is different from the second kernel size.

23. The system of claim 22, wherein the first processor is to blend an output of the first descreen operation with an output of the second descreen operation to generate the first lowpass filtered image.

24. The system of claim 21, further comprising a host processor to transmit configuration data to the number of processors for generation of a logical connection between the first processor and the second processor.

25. The system of claim 24, wherein the first processor is to transmit the first lowpass filtered image through the logical connection to the second processor.

26. The system of claim 25, wherein the logical connection includes connection paths that includes a third processor, wherein no processor element in the third processor is involved in transmission of the first lowpass filtered image through the logical connection.

27. A machine-readable medium that provides instructions which, when executed by a machine, cause said machine to perform operations comprising:
receiving a control signal to indicate that an image that is to be descreened; and
transmitting configuration data for establishing a first logical connection between a first image signal processor that is to remove a Moiré pattern associated with the image and a second image signal processor that is to combine edge information to an output the first image signal processor to generate a descreened image.

28. The machine-readable medium of claim 27, wherein transmitting configuration data for establishing the first logical connection comprises transmitting configuration data for establishing the first logical connection from the first image signal processor to the second image signal processor that includes connection paths through a port ring of at least one other image signal processor.

29. The machine-readable medium of claim 27, further comprising transmitting configuration data for establishing a second logical connection between the second image signal processor and a memory, wherein the second image processor is to transmit the descreened image through the second logical connection for storage in the memory.
